(19) United States
(12) Patent Application Publication
(10) Pub. No.: US 2024/0114369 A1
(43) Pub. Date: Apr. 4, 2024

(54) DYNAMIC SCAN DURATION CONTROL

(71) Applicant: Apple Inc., Cupertino, CA (US)

(72) Inventors: Dongwoon Hahn, San Jose, CA (US); Chen Ganir, San Jose, CA (US); Duy N. Phan, Los Gatos, CA (US)

(73) Assignee: Apple Inc., Cupertino, CA (US)

(21) Appl. No.: 18/473,158

(22) Filed: Sep. 22, 2023

Related U.S. Application Data
(60) Provisional application No. 63/409,682, filed on Sep. 23, 2022.

(51) Int. Cl. H04W 24/08

(52) U.S. Cl. CPC H04W 24/08

(57) ABSTRACT

The present application relates to devices and components including apparatus, systems, and methods to dynamically adjust a scanning duration for packets. In some embodiments, a device can extend a scanning duration for advertising packets based at least in part on a detected scanning interruption.

### CROSS-REFERENCE TO RELATED APPLICATIONS

This application claims the benefit of, and priority to, U.S. provisional application No. 63/409,682, entitled “Dynamic Scan Duration Control,” filed on Sep. 23, 2022, the disclosure of which is incorporated by reference herein in its entirety for all purposes.

### TECHNICAL FIELD

The subject matter described herein relates to a system and method for dynamic scan duration control in a wireless network.

### BACKGROUND

With the development of wireless communication, devices within networks perform procedures to discover other devices and/or services provided by the networks. One of these approaches implemented by devices for discovery of other devices and/or services provided by the networks includes providing advertising packets and scanning for the advertising packets.

In order to perform the scanning for advertising packets, a device may utilize resources and device power to scan for packets within a frequency range. However, other operations and/or transmissions being performed within the system may interfere (including reducing the quality of the scanning) with the scan operation. The interference with the scanning can cause issues with discovering other devices and/or services provided by the networks while still tying up the resources and using the device power for performing the scanning.

### BRIEF DESCRIPTION OF THE DRAWINGS

FIG. 1 illustrates an example scanning arrangement in accordance with some embodiments.

FIG. 2 illustrates an example scan agent arrangement in accordance with some embodiments.

FIG. 3 illustrates example fixed scan duration legacy approach representations.

FIG. 4 illustrates example scan duration approach representations in accordance with some embodiments.

FIG. 5 illustrates an example scan duration representation for multiple scan agents on different scan parameters in accordance with some embodiments.

FIG. 6 illustrates an example scan representation for multiple scan agents in accordance with some embodiments.

FIG. 7 illustrates an example procedure for a scan in accordance with some embodiments.

FIG. 8 illustrates an example procedure for a scan in accordance with some embodiments.

FIG. 9 illustrates an example system arrangement in accordance with some embodiments.

FIG. 10 is a block diagram of an example computing device that can implement the features and processes of FIGS. 1-9 in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Embodiments described herein may include a dynamic scan duration control system and method in a wireless network. For example, embodiments described herein may control scan durations of scans performed by a device to discover other devices and/or services within a network. A device may initiate a scan and monitor for interruptions to the scan. Based on the device detecting interruptions to the scan, the device may determine to extend a duration of the scan based on a duration of the interruptions. By extending the scan based on the duration of the interruptions, the device may have sufficient time for the scan operations associated with the scan while preventing or reducing the chance of the scan extending for longer than needed, which would tie up resources and/or use additional device power that is not needed for properly performing the scan.

Implementations of the current subject matter can include, but are not limited to, methods consistent with the descriptions provided herein as well as articles that comprise a tangibly embodied machine-readable medium operable to cause one or more machines (for example, computers, etc.) to perform operations implementing one or more of the described features herein. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (for example, the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a dynamic scan duration control, it should be readily understood that such features are not intended to be limiting. The claims that follow this disclosure are intended to define the scope of the protected subject matter.

In wireless connectivity and wireless networks, scanning is used for multiple purposes including device discovery, retrieval of information from discovered devices, connection procedures, and/or determining the proximity or range, based on the information retrieved from the received packets, such as a Received Signal Strength Indication (RSSI) packet. This is done by receiving packets (so called advertising packet in Bluetooth low energy (LE)) from devices (so called advertisers in Bluetooth LE). Advertisers can broadcast advertising packets, and scanners can decide which advertising packets to process based on their interests. For example, advertising devices may transmit advertising packets that include information that can be utilized for device discovery, retrieval of information, connections and/or determining proximity or range of the advertising devices. Another device (which may be referred to as a scanning device or a scanner) may scan for the advertising packets transmitted by the advertising devices and utilize the detected advertising packets to perform one or more operations.

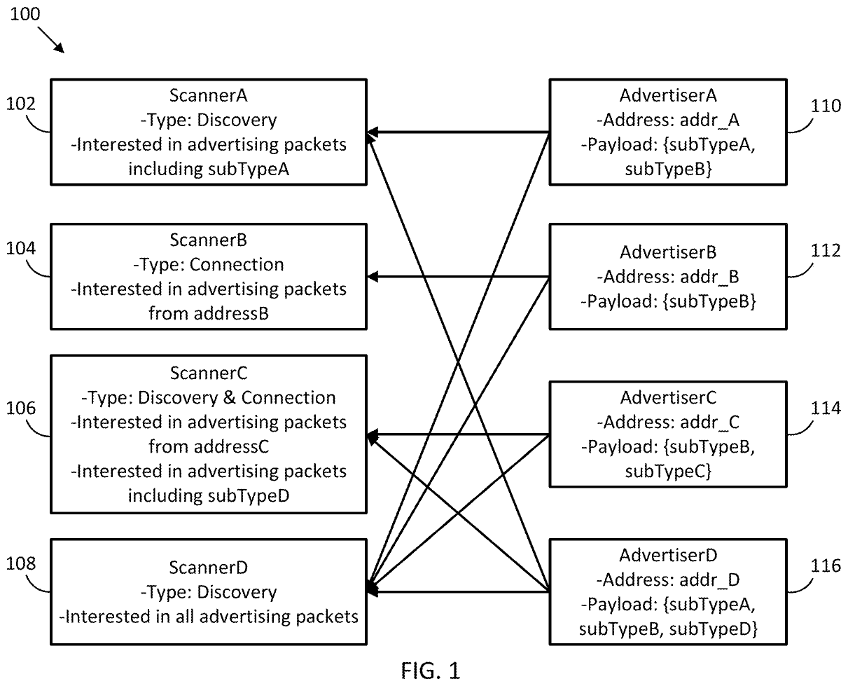

FIG. 1 illustrates an example scanning arrangement 100 in accordance with some embodiments. In particular, the scanning arrangement 100 illustrates an example arrangement of scanning devices and advertising devices to illustrate features of scanning operations that can be implemented with the approaches described herein. The illustrated scanning arrangement 100 illustrates an example of a Bluetooth LE arrangement, although it should be understood that the approaches described herein may be implemented in other wireless systems where scanning is implemented.

The scanning arrangement 100 may include one or more scanning devices. In the illustrated embodiments, the scanning arrangement 100 includes a first scanning device 102, a second scanning device 104, a third scanning device 106, and a fourth scanning device 108. Each of the scanning devices may perform scans for receiving advertising packets transmitted by advertising devices.

The scans performed by the scanning devices may be perform for different types of scan operations, where the different types of scan operations may be performed for different purposes. In the illustrated embodiment, the scanning operations include a discovery type scanning operation and a connection type scanning operation. The discovery type scanning operation may be performed to discover devices within a proximity of the scanning device performing the discovery type scanning operation. The connection type scanning operation may be performed to identify and obtain information from devices with which the scanning device performing the connection type scanning operation is seeking to connect. The scanning operations may further include addresses and/or payload types for which the scanning device is seeking advertising packets.

In the illustrated embodiment, the first scanning device 102 may be performing a discovery type scanning operation. Further, the first scanning device 102 may be seeking (for example, performing active scanning) advertising packets of payload type subTypeA. The second scanning device 104 may be performing a connection type scanning operation. Further, the second scanning device 104 may be seeking advertising packets from addressB. The third scanning device 106 may be performing a discovery type scanning operation and a connection type scanning operation. Further, the third scanning device 106 may be seeking advertising packets from addressC and of payload type subTypeD. The fourth scanning device 108 may be performing a discovery type scanning operation. Further, the fourth scanning device 108 may be seeking all advertising packets.

The scanning arrangement 100 may include one or more advertising devices. In the illustrated embodiment, the scanning arrangement 100 includes a first advertising device 110, a second advertising device 112, a third advertising device 114, and a fourth advertising device 116. Each of the advertising devices may transmit advertising packets. The advertising devices may broadcast or multicast the advertising packets.

Each of the advertising devices may be assigned a corresponding address. Further, each of the advertising devices may transmit payloads of certain types. In the illustrated embodiment, the first advertising device 110 may have an address of addr_A, and may advertise payloads of subTypeA and subTypeB. The second advertising device 112 may have an address of addr_B and may advertise payloads of subTypeB. The third advertising device 114 may have an address of addr_C, and may advertise payloads of subTypeB and subTypeC. The fourth advertising device 116 may have an address of addr_D, and may advertise payloads of subTypeA, subTypeB, and subTypeD.

In the illustrated embodiment, the first scanning device 102 may scan for advertising packets from the first advertising device 110 and the fourth advertising device 116 based on the first advertising device 110 and the fourth advertising device 116 transmitting advertising packets of subTypeA of which the first scanning device 102 is seeking advertising packets. The second scanning device 104 may scan for advertising packets from the second advertising device 112 based on the second advertising device 112 having the address of addr_B of which the second scanning device 104 is seeking advertising packets. The third scanning device 106 may scan for advertising packets from the third advertising device 114 and the fourth advertising device 116 based on the third advertising device 114 having the address of addr_C of which the third scanning device 106 is seeking advertising packets and the fourth advertising device 116 transmitting advertising packets of subTypeD of which the third scanning device 106 is seeking advertising packets. The fourth scanning device 108 may scan for advertising packets from the first advertising device 110, the second advertising device 112, the third advertising device 114, and the fourth advertising device 116 based on the fourth scanning device 108 seeking advertising packets of all payload types.

Each of the scanning devices may perform scans for the advertising packets described above. The scans performed by the scanning devices may include each of the scan type operations being performed by the device. For example, a scan performed by the third scanning device 106 may include the discovery type scan operation and the connection type scan operation. The scanning devices may process the advertising packets identified during the scans and perform the operations corresponding to the types of scan operations with the information from the advertising packets.

Once the goals for scanning have met, the scanning can be terminated. As an example, in device discovery, the scanning can be terminated upon achieving confidence to discover all interested devices over a wireless channel. In another example, scanning can be completed if the interested device is not discovered within a certain timeout. In case of connection scanning (when scanning is used as a part of connection procedure), scanning can be terminated if the peer device is not discovered within a certain timeout or connection to the peer device is made. In practice, the decision on scan duration or when to terminate the scanning are not trivial issues since the quality and efficiency of scanning are affected by many factors which may not be controlled by the scanning devices.

The quality of scanning can be affected by conditions and factors. For example, one or more conditions and/or factors can positively or negatively affect the quality of scanning during a scan. The conditions and/or factors can occur at the scanning devices, at the advertising devices, and/or on the radio channels. Below is a discussion of the conditions and/or factors that can affect the quality of scanning.

Conditions on Scanning Devices

The conditions and/or factor that can occur at the scanning device may include scan parameters, coexistence (coex) conditions, and other conditions. The scan parameters are usually defined by window and interval, and the duty cycle can be window/interval*100(%). The scan parameters can be determined by scanner depending on the latency requirement, power budget, etc.

Coex conditions can include conditions related to other operations performed by the scanning devices. Usually the scanner device has to support multiple functions and features at the same time and the scanner device may have to share the operating channels with other wireless interfaces on the same device. For example, Bluetooth LE on 2.4 gigahertz (GHz) may have to share the channels with Wi-Fi interface on 2.4 GHz on the same device. Other traffic the scanner device may have to support in transmission or reception can also affect the quality of scanning. As an example, the quality of scanning by a Bluetooth LE scanner may be affected if the device has to use the same Bluetooth interface for audio streaming or data transfer while the device has to scan.

Other conditions may include if the radio channel is busy with many advertisers and if the scanner has to process a high volume of advertising packets, this may affect the quality of scanning. In other words, when there are many advertisers found on the channel, in order to secure the same actual amount of scanning time, the device may have to scan for a longer duration since each receipt of advertising packet may result in overhead in scanning.

Conditions on Advertising Devices

Advertising parameters of devices to be discovered may affect the quality of the scanning. Notable advertising parameters may include advertising interval where advertising packets are sent at every advertising interval. In case of Bluetooth LE, advertising packets may be sent over each advertising channel at every advertising interval. This is usually not controlled by the scanner.

Conditions on Radio Channels

Radio conditions may affect the quality of scanning. Various interference which may not be from involved devices such as any other communicating devices which are not coordinated with the involved scanners and advertisers, and other non-communication interference on the band overlapping with advertising channels. Various fading caused by mobility of scanner/advertisers and other devices on the channel and other impairments can affect the quality of scanning. Since the quality of scanning is affected by many conditions which may not be controlled by the scanner, it is not easy to determine when to terminate the scanning.

Since the quality of scanning is affected by many conditions which may not be controlled by the scanner, it is not easy to determine when to terminate the scanning.

On a scanning device, multiple features can be supported, and scanning for each feature or use case can be represented as a software scan agent. Each scan agent may have different requirements and interests such as, without limitation: Scanning types, such as discovery, connection, proximity decision, etc.; interest based on the identity (address) of the advertisers; and interest based on the payload (types of information in the advertising packets) of the advertisers.

When there are multiple scan agents on a scanning device, they can be combined into a single scanning instance at the wireless interface while multiplexing and demultiplexing are done to serve each scan agent. For example, a scanning device may perform a scan that fulfills the properties of each of the scan agents seeking a scan operation to be performed. Each scan agent can define certain scan parameters, scan types, and/or advertising packet interests for the scan agent. The scan agents can provide information to a scanner to perform scan to fulfill the scan operations for the scan agents.

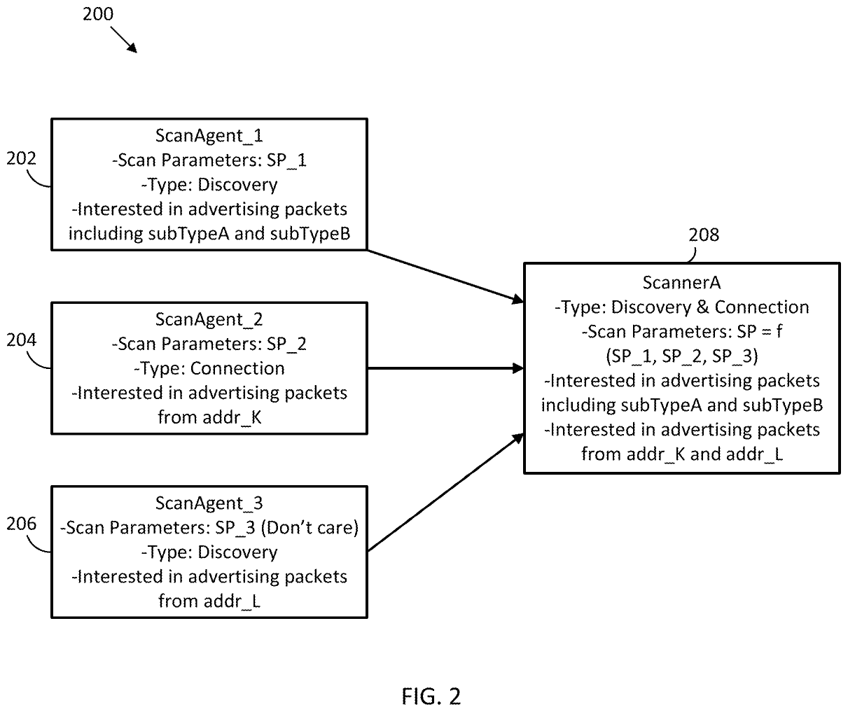

FIG. 2 illustrates an example scan agent arrangement 200 in accordance with some embodiments. For example, the scan agent arrangement 200 illustrates within a device that may be utilized for performing a scan. The elements within the scan agent arrangement 200 may be software of the device, hardware of the device, or some combination thereof.

The scan agent arrangement 200 may include one or more scan agents. In the illustrated embodiment, the scan agent arrangement 200 includes a first scan agent 202, a second scan agent 204, and a third scan agent 206. Each of the scan agents may be part of software operating on the device.

Further, each of the scan agents may define scan parameters, type of scan operations, and/or advertising packet interests for the scan agent. In the illustrated embodiment, the first scan agent 202 has scan parameters of SP_1, has a discovery type of scan operation, and is interested in advertising packets of payload types subTypeA and subTypeB. The second scan agent 204 has scan parameters of SP_2, has a connection type of scan operation, and is interested in advertising packets from addr_K. The third scan agent 206 has scan parameters of SP_3, has a discovery type of scan operation, and is interested in advertising packets from addr_L.

The scan agent arrangement 200 may include a scanner 208. The scanner 208 may be a physical layer that can facilitate scanning. For example, the scanner 208 may include software and/or hardware that can scan for and receive advertising packets.

The scan agents can provide the scan parameters, the types of scan operations, and/or the advertising packet interests to the corresponding scanner to perform one or more scans for advertising packets in accordance with the information provided by the scan agents. In the illustrated embodiment, the first scan agent 202, the second scan agent 204, and the third scan agent 206 may provide the scan parameters, the types of scan operations, and/or the advertising packet interests to the scanner 208. Based on the information received from the scan agents, the scanner 208 may be configured to perform discovery and connection scan operations. Further, the scanner 208 may be configured to perform the scan with scanning parameters based on the scanning parameters SP_1, SP_2, and SP_3 provided by the scan agents. The scanner 208 may be configured to perform the scan for advertising packets of payload subTypeA, advertising packets of payload subTypeB, advertising packets from addr_K, and advertising packets from addr_L. The scanner 208 may perform one or more scans in accordance with the configuration and may provide the identified advertising packets to the corresponding scan agent for processing.

In legacy state of the art, there are multiple ways to determine scanning duration for a scanning from a scan agent. For a first approach, the scan duration is fixed regardless of the conditions affecting the quality of scanning. For a second approach, the scan duration is determined by one or more parameters the scanner can control, such as scan parameters. For a third approach, the scan duration is determined in accordance with an estimation of how one or more other conditions may affect the scanning. Some of the conditions affecting scanning quality may not be known to the scanner at the start of scanning. Estimation at the beginning of scanning may not be accurate since impairments may vary over time. Two or more of the approaches can be combined in some embodiments.

In the legacy state of the art, the scanning duration of a scan conducted by a scan agent may not take into consideration another scan running for another scan agent at the same time. For example, a scan duration for a scan agent may be determined based on a 10% scan parameter duty cycle for the scan agent. However, the scan agent may actually get a higher scanning duty cycle, e.g., due to scanning from other scan agents running on a 100% scan parameter duty cycle.

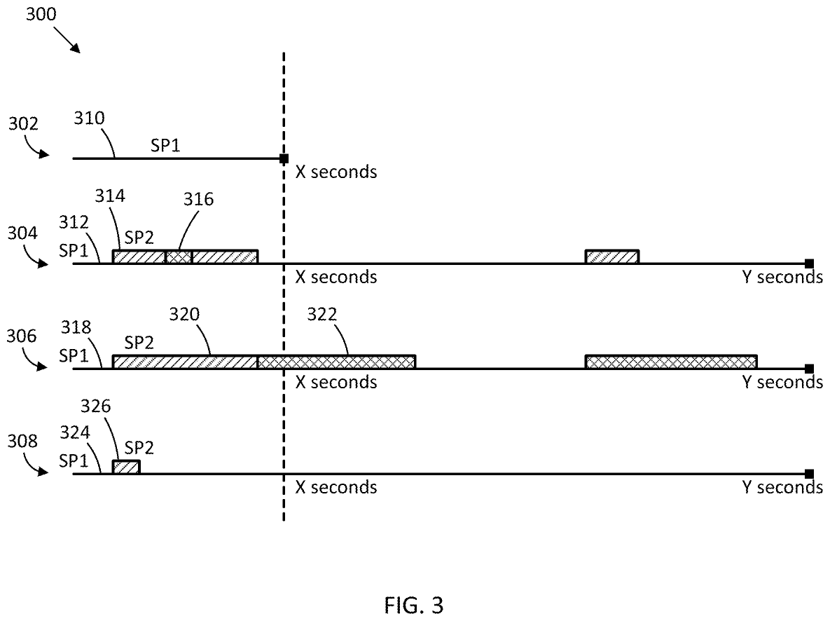

FIG. 3 illustrates example fixed scan duration legacy approach representations 300. For example, the fixed scan duration legacy approach representations 300 show how the scan duration for a scan agent is determined in a legacy fixed scan duration approach (when the approaches described in this disclosure are not applied). In this example, the scan parameter is updated upon detecting a condition in which the performance of one or more other tasks is affected by scanning. In order to protect one or more other tasks, the scan parameter can be updated. In this example, SP1 is used when scanning does not affect other tasks, and SP2 is used when scanning affects one or more other tasks. Upon detecting a condition in which scanning affects one or more other tasks, the scan parameter switches from SP1 to SP2. In this example, the time out or scan duration is X seconds (where X can represent any time period, measuring less than 1 second to multiple seconds) in an idle condition, but when either scanning affects the other tasks or other tasks affect the scanning, the scan duration may be extended to Y seconds (where Y can represent any time period, measuring less than 1 second to multiple seconds), e.g., while using scan parameter SP2 that has a lower duty cycle than SP1. Scan duration also may be extended in order to compensate for the change in scan parameters.

The fixed scan duration legacy approach representations 300 include a first representation 302, a second representation 304, a third representation 306, and a fourth representation 308. Each of the representations illustrate different instances that can occur during a scan.

In the first representation 302, a scanner may initiate a scan 310 (as illustrated by the line) for one or more scan agents. The scan 310 may be initially configured for a duration of X seconds. The device that includes the scanner may not detect any interference (e.g., conditions that affect the scan and/or the scanning affecting other tasks) during the scan. As the device does not detect any interference, the scanner may perform the scan 310 using the scan parameter(s) SP1 and for the duration of X seconds.

In the second representation 304, a scanner may initiate a scan 312 (as illustrated by the line) for one or more scan agents. The scan 312 may be initially configured for a duration of X seconds. Further, the scan 312 may initiate the scan with scan parameter(s) SP1. The device that includes the scanner may detect interference during the scan duration. For example, the device may identify one or more coexistence conditions 314 that can affect the scan 312 and/or other transmission operations 316 (such as Bluetooth and/or Wi-Fi transmission operations) that can affect the scan 312. Based on the device detecting the interference, the scan 312 may transition to using scan parameter(s) SP2 and extending to the predefined duration of Y seconds.

In the third representation 306, a scanner may initiate a scan 318 (as illustrated by the line) for one or more scan agents. The scan 318 may be initially configured for a duration of X seconds. Further, the scan 318 may initiate with scan parameter(s) SP1. The device that includes the scanner may detect interference during the X seconds duration. For example, the device may identify coexistence conditions 320 that can affect the scan 318 and/or other transmission operations 322 (such as Bluetooth and/or Wi-Fi transmission operations) that can affect the scan 318. Based on the device detecting the interference, the scan 318 may transition to using scan parameter(s) SP2 and extend to the predefined duration of Y seconds.

In the fourth representation 308, a scanner may initiate a scan 324 (as illustrated by the line) for one or more scan agents. The scan 324 may be initially configured for a duration of X seconds. Further, the scan 324 may initiate with scan parameter(s) SP1. The device that includes the scanner may detect interference during the X seconds duration. For example, the device may identify coexistence conditions 326 that can affect the scan. Based on the device detecting the interference, the scan 324 may transition to using scan parameter(s) SP2 and extending to the predefined duration of Y seconds.

As seen from the examples, the compensation achieved by extending a scan duration can be either over-compensation (the second representation 304 and the fourth representation 308 from FIG. 3) or under-compensation (the third representation 306 from FIG. 3). In the fourth representation 308, even though the duration of impairments is brief, the scan adjustment may over-compensate by a large margin. For example, the amount of time that the scan 312 in the second representation 304 proceeds without interference (as illustrated by the boxes with diagonal and cross-hatched lines) during the extended duration of Y seconds may be longer than necessary to properly perform the scan 312. For the third representation 306, the amount of time that the scan 318 proceeds without interference (as illustrated by the boxes with diagonal and cross-hatched lines) during the extended duration of Y seconds may be shorter than necessary to properly perform the scan 318. For the fourth representation 308, the amount of time that the scan 324 proceeds without interference (as illustrated by the boxes with diagonal and cross-hatched lines) during the extended duration of Y seconds may be much longer than necessary to properly perform the scan 324.

In this disclosure, the approach to dynamically determine the scan duration for each “scan agent” is described. When there are multiple scan agents, the scanning from all scan agents may be combined and the wireless interface may run a single global instance of scanning. Each scan agent can determine when to stop the scanning. For example, a scan agent may determine when to stop a scan for a scanning operation corresponding to the scan agent Whenever a scan agent starts or stops scanning, the parameters for the scanning device may be updated. The method on how to stop scanning on a “scanning device” are also described.

The approaches described herein may present some of the following, but non-limiting, advantages. As one advantage, the duration of scanning may be adapted (e.g., dynamically) to the conditions affecting the scanning quality. By dynamically controlling the duration of scanning, the amount of actual scanning time required to support the function can be utilized by a scan agent.

As another advantage, the approaches can avoid over-compensation for impairments affecting the quality of scanning. By avoiding over-compensation, these approaches can achieve the desired scanning performance while not unnecessarily consuming power. Also, by scanning only as long as needed, these approaches can help other tasks using the same wireless interface or sharing the same wireless face by releasing the radio resources used by scanning for use in other tasks.

As another advantage, the approaches can avoid under-compensation for the impairments affecting the quality of scanning. The approaches may help to avoid early termination of scanning (and thus obtaining incomplete scanning results) when scanning quality has been compromised during the scanning.

As another advantage, the duration of scanning for a single scan agent may be determined by taking all scanning agents at system-level into account. By doing so, the decision for each scan agent may be improved, since the decision is made using all information available collectively, instead of in isolation.

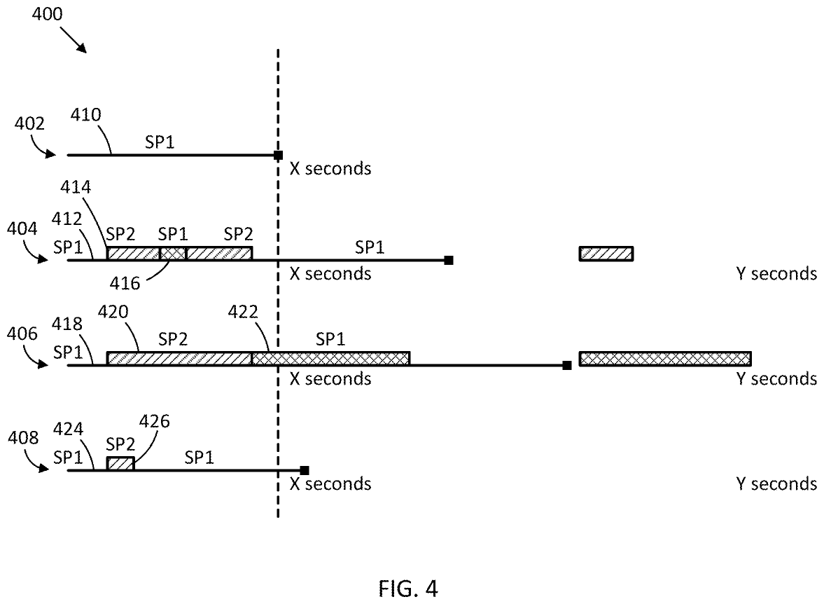

FIG. 4 illustrates example scan duration approach representations 400 in accordance with some embodiments. The scan duration approach representations 400 show examples of how the scan duration for a scan agent may be determined in accordance with approaches described in this disclosure. Compared to legacy examples in FIG. 3, the scanning duration of the approaches represented by the scan duration approach representations 400 may change (e.g., dynamically) in response to one or more internal and/or external conditions that can affect the scan parameters and/or scanning performance. Further, the scan duration may be controlled in a way that avoids over- and under-compensation. Not extending the scan duration to a fixed value, e.g., Y seconds (unless in accordance with the approaches described herein of extending based on interference), but rather by extending the scan duration only as much as needed, can help reduce the power consumption associated with scanning and/or release radio resource sooner, e.g., to perform one or more other tasks.

The scan duration approach representations 400 include a first representation 402, a second representation 404, a third representation 406, and a fourth representation 408. Each of the representations illustrate different instances that can occur during a scan.

In the first representation 402, a scanner may initiate a scan 410 (as illustrated by the line) for one or more scan agents. The scan 410 may be initially configured for a duration of X seconds. The device that includes the scanner may not detect any interference (e.g., conditions that affect the scan and/or the scanning affecting other tasks) during the scan. Based on the device not detecting any interference, the scan agents may determine that the duration of the scan is not to be extended. As the device does not detect any interference, the scanner may perform the scan 410 using the scan parameters SP1 and for the duration of X seconds.

In the second representation 404, a scanner may initiate a scan 412 (as illustrated by the line) for one or more scan agents. The scan 412 may be initially configured for a duration of X seconds. Further, the scan 412 may initiate with scan parameters SP1.

The device that includes the scanner may detect interference during the scan duration. In particular, the device may identify one or more coexistence conditions 414 that can affect the scan 412 and/or other transmission operations 416 (such as Bluetooth and/or Wi-Fi transmission operations) that can affect the scan 412. The device may determine a duration of the interference caused by the coexistence conditions 414 and the other transmission operations 416.

Based on the device detecting the interference, the scan agents may determine to extend the duration of the scan 412 based on the determined duration of the interference. In some embodiments, the duration of the scan 412 may be extended by the duration of the interference. In some embodiments, the duration of the scan 412 may be extended by a combination of the duration of the interference and one or more duty cycles being implemented by the scan. For example, the duration of the scan 412 may be extended by a duration needed to obtain a required number of samples, e.g., determined based on the duration of the interference and the duty cycles. Extending the scan duration based at least in part on the duration of the interference can result in the scan 412 ending prior to the fixed scan extension duration (e.g., Y seconds) used by the legacy approach. As a result, resources used for the scan 412 may be released earlier than under the legacy approaches and/or the amount of power consumed by extending the scan duration can be reduced in comparison to legacy approaches. In addition to extending the duration of the scan, one or more scan parameters SP2 may be changed when the coexistence conditions 414 are present. One or more scan parameters SP1 may be used (or resumed) when the coexistence conditions 414 are absent/no longer present.

In the third representation 406, a scanner may initiate a scan 418 (as illustrated by the line) for one or more scan agents. The scan 418 may be configured for an initial scan duration (e.g., X seconds). Further, the scan 418 may initiate with scan parameters SP1. One or more interference conditions may be detected during the initial scan duration. For example, the device may identify one or more coexistence conditions 420 that can affect the scan 418 and/or other transmission operations 422 (such as Bluetooth and/or Wi-Fi transmission operations) that can affect the scan 418. The device may determine a duration of the interference caused by the coexistence conditions 420 and/or the other transmission operations 422.

In response to the interference, the scan agent(s) may determine to extend the duration of the scan 418, e.g., based on the duration of the interference. In some embodiments, the duration of the scan 418 may be extended by the duration of the interference. In some other embodiments, the scan duration may be extended by a duration that exceeds the duration of the interference by a margin (e.g., a cushion). In still other embodiments, the duration of the scan 418 may be extended based on a combination of the duration of the interference and one or more duty cycles being implemented by the scan. For example, the duration of the scan 418 may be extended by a duration needed to obtain a required number of samples, e.g., based on the duration of the interference and the duty cycles. By dynamically extending the scan duration in relation to the duration of the interference, the scan 418 may end prior to a scan extended by a default extension duration (e.g., Y seconds) used by a legacy approach. As a result, resources for the scan 418 may be released earlier than under legacy approaches and/or less power may be expended on scanning. Further, one or more scan parameters SP2 may be used when the coexistence conditions 420 are present and one or more scan parameters SP1 may be used when the coexistence conditions 420 are absent.

In the fourth representation 408, a scanner may initiate a scan 424 (as illustrated by the line) for one or more scan agents. The scan 424 may be initially configured for a default scan duration (e.g., X seconds). Further, the scan 424 may be initiated with scan parameters SP1. Interference may be detected during the default scan duration (e.g., X seconds). For example, the device may identify coexistence conditions 426 that can affect the scan 424. A duration of the interference caused by the coexistence conditions 426 can be determined.

Based on the detected interference, the duration of the scan 424 may be extended, e.g., based on the determined duration of the interference. In some embodiments, the duration of the scan 424 may be extended by the duration of the interference. In some other embodiments, the duration of scan 424 may be extended based on the duration of the interference and a padding value (e.g., a fixed value or a percentage of the interference duration). In still other embodiments, the duration of the scan 424 may be extended by a combination of the duration of the interference and one or more duty cycles being implemented by the scan. For example, the duration of the scan 424 may be extended by a duration needed to obtain a required number of samples, e.g., determined based on the duration of the interference and the duty cycles. As a result of extending the scan duration based at least in part on the duration of the interference, the scan 424 may end prior to the extended scan duration (e.g., Y seconds) the fixed scan duration legacy approach extends the scan. This can cause resources for the scan 424 may be released earlier than under legacy approaches and/or power utilized for scanning may be reduced. Further, the scan may change to scan parameters SP2 when the coexistence conditions 426 are present and can switch back to scan parameters SP1 when the coexistence conditions 426 are absent.

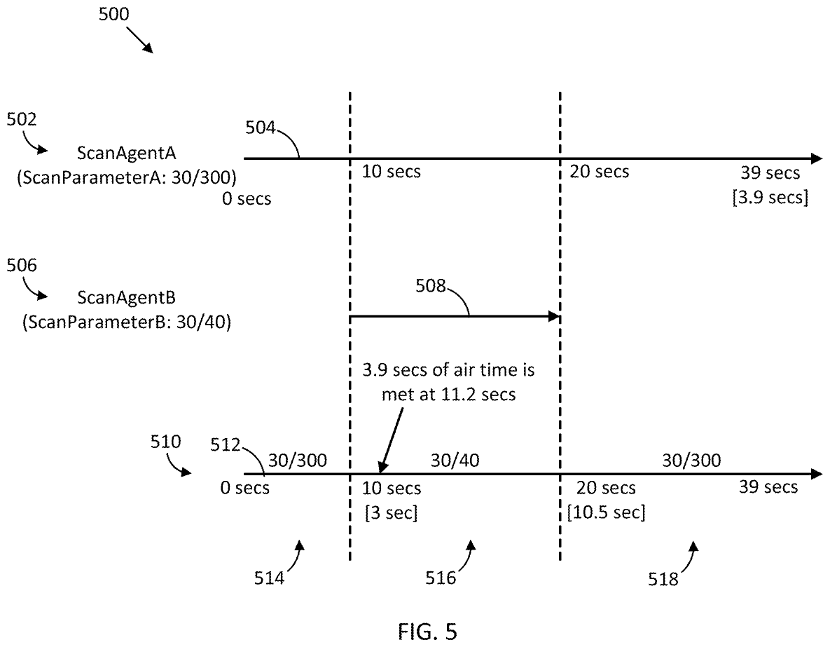

FIG. 5 illustrates an example scan duration representation 500 for multiple scan agents on different scan parameters in accordance with some embodiments. The scan duration representation 500 shows an example where multiple scan agents request scanning is provided. In many legacy implementations, when each scan agent requests different scan parameters (different scan duty cycle), the scan parameter with the maximum duty cycle is chosen. By not considering the scanning from other scan agents on the same scanning device, there is a chance that the selected scan duration may be too long for a scan agent if it is determined based on the local information for a scan agent only. In this example, between t=10 secs and t=20 secs, due to having scanning from ScanAgentB, ScanAgentA will gets 30/40 (75%) duty cycle scanning even though it only requests 30/300 (10%) duty cycle scanning.

For example, the scan duration representation 500 includes a first representation 502. The first representation 502 illustrates an example scan that is requested by a first scan agent (which may be referred to as ScanAgentA). The first scan agent may request a scan 504 (as illustrated by the line) with a duration of 104 seconds starting at a relative time of 0 seconds. The first scan agent may additionally request that the scan 504 be performed with a duty cycle of 10% (defined as ScanParameterA: 30/300). Accordingly, the first scan agent may be requesting 10.4 seconds of active scanning based on the duration of 104 seconds and the duty cycle of 10%

The scan duration representation 500 includes a second representation 506. The second representation 506 illustrates an example scan that is requested by a second scan agent (which may be referred to as ScanAgentB). The second scan agent may request a scan 508 (as illustrated by the line) with a duration of 10 seconds starting at a relative time of 10 seconds. The second scan agent may additionally request that the scan 508 be performed with a duty cycle of 75% (defined as ScanParameterA: 30/40). Accordingly, the second scan agent may be requesting 7.5 seconds of active scanning based on the duration of 10 seconds and the duty cycle of 75%.

The scan duration representation 500 includes a third representation 510. The third representation 510 illustrates an example scan that may be performed by a scanner based on the scans requested by the first can agent and the second agent. The scanner may initiate a scan 512.

During a first portion 514 of the scan 512 extending from 0 seconds to 10 seconds only the first scan agent may be requesting a scan operation. As only the first scan agent is requesting the scan operation, the scanner may perform the scan 512 with the duty cycle of 10% for the first portion 514 in accordance with the duty cycle defined by the first scan agent. 1 second of active scanning may be completed from 0 seconds to 10 seconds based on the duration being 10 seconds and the duty cycle being 10%

During a second portion 516 of the scan 512 extending from 10 seconds to 20 seconds both the first scan agent and the second scan agent may be requesting scan operations. The scanner may determine to utilize the highest duty cycle of requested duty cycles when more than one scan agent is requesting scan operations. In the illustrated embodiment, the scanner may determine to utilize the 75% duty cycle of the second scan agent for the second portion 516 based on the 75% duty cycle being higher than the 10% duty cycle requested by the first scan agent. Accordingly, the scanner may perform the scan 512 with the duty cycle of 75% for the second portion 516 in accordance with the determined duty cycle. 7.5 seconds of active scanning may be completed from 10 to 20 seconds based on the duration being 10 seconds and the duty cycle being 75%.

During a third portion 518 of the scan 512, the scan operation requested by the second scan agent may be completed and only the first scan agent is requesting a scan operation. As only the first scan agent is requesting the scan operation, the scanner may perform the scan 512 with the duty cycle of 10% for the third portion 518 in accordance with the duty cycle defined by the first scan agent. 1.9 seconds of active scanning may be completed from 20 to 39 seconds based on the duration being 19 seconds and the duty cycle being 10%.

As 1 second of active scanning is completed from 0 to 10 seconds, 7.5 seconds of active scanning is completed from 10 to 20 seconds, and 1.9 seconds of active scanning is completed from 20 seconds to 39 seconds, a total amount of active scanning time from 0 to 39 seconds is 10.4 seconds. Since the first scan agent requested an active scanning time of 10.4 seconds and the second scan agent requested an active scanning time of 7.5 seconds, both the request from the first scan agent and the second scan agent may be fulfilled at 39 seconds. The scanner may terminate the scan at 39 seconds as both the request of the first scan agent and the request of the second scan agent have been fulfilled. Since the first scan agent originally requested a duration of 104 seconds, but the active scanning time of the first scan agent was completed with the 39 seconds, the scan time for the first scan agent may be reduced from 104 seconds to 39 seconds in the illustrated embodiment. This approach of having multiple scan agents being serviced by a scanner at the same time can result in a reduction of scan duration of a scan (as illustrated by the scan duration representation), which can result in less use of power for the scan and resources utilized for the scan being released early as compared to multiple scan agents being unable to be serviced at the same time.

Devices described throughout this disclosure may have two types of entities, a Scanner and a Scan Agent. The scanning device or scanner may be a combination of software and hardware. The scanner may be capable of controlling the radio interface to receive the advertising packets and filter them based on the interest. The scanner can be configured with scan parameter which is typically represented by window and interval where duty cycle is window/interval*100(%). Each scanner may also be responsible to aggregate the requests from scan agents to determine the interest (or so called filtering) and to determine the global scan parameters that shall be applied on the radio interface.

In the context of Bluetooth, the scanner may be the embodiment of hardware, controller, firmware, and some host stack interfacing with the controller. Scan agent may represent the scanning done for a specific use case, an application or feature which may usually be implemented as software. In the context of Bluetooth, Scan agent may be the embodiment of applications running on top of host stack interfacing with host stack. As seen in the scan agent arrangement 200 of FIG. 2, there may be multiple scan agents, and each scan agent may become active or inactive based on the need from the applications. This disclosure provides approaches for determining scan duration for a scan agent.

Functionalities of the Scanner

Scanner may be able to count the actual amount of scan time statistics. Whenever (1) scanner has to stop and restart scanning and (2) scanner sees scanning is not scheduled as configured by scan parameters (for example, such as serving other types of traffic while blocking scanning), these conditions may be considered in stopping and restarting counters. When there are conditions known to affect scanning performance but not fully blocking scanning in scanner, scanner may be able to factor those conditions into account on incrementing the counter (such as incrementing counter slower than wall clock).

The scanner can be configured with threshold values in terms of the actual amount of scan time statistics. The actual amount of scan time statistics may be defined by a set of statistics such as the actual amount of scan time from all cores and/or the actual amount of scan time from a specific core when multiple cores are available for scanning. The actual amount of scan time threshold value may be set for each scanning type (described herein) which includes discovery scan and connection scan.

As an example, when the scanner supports two types of scanning, discovery, and connection scan and when there are N cores that can scan, the following set of threshold values may be configured. For Discovery scan type, a Total Amount of Discovery Scan Time and/or an Amount of Discovery Scan Time on Core X where X is in {1, . . . , N} may be configured. For Connection scan type, a Total Amount of Connection Scan Time and/or an Amount of Connection Scan Time on Core X where X is in {1, . . . , N} may be configured.

By having the threshold value per each core, it can help to deal with a situation where the statistics from some specific cores have issues in counting statistics with high fidelity. For example, if it is known that Core K and Core L have issues in counting statistics, the threshold value can be set to a value which indicates that counting is not needed.

Once the scanner sees the threshold value is met by its counters, it can determine which scan agents can stop the scanning. The scanner can be able to compute the threshold values based on the requirements and the remaining actual scan time for each scan agent.

Functionalities of the Scan Agent

Scan Agent may be able to translate its requirements for feature/application to the actual amount of scan time and may provide this information when scanning starts with the scanner.

Threshold values described above can be recomputed and applied on the scanner whenever scanning starts or stops for a scan agent. For the purpose of explanation, it may be assumed that there are two types of scanning (discovery and connection) and two cores (A and B). Then there may be six threshold values and counters, which may be:
Threshold_Discovery_Total={Total Amount of Discovery Scan Time}
Threshold_Discovery_CoreA={Amount of Discovery Scan Time on Core A}
Threshold_Discovery_CoreB={Amount of Discovery Scan Time on Core B}
Threshold_Connection_Total={Total Amount of Connection Scan Time}
Threshold_Connection_CoreA={Amount of Connection Scan Time on Core A}
Threshold_Connection_CoreB={Amount of Connection Scan Time on Core B}

Not all scan agents may set the threshold values and may not try to use the closed loop scanning for dynamic scan duration decision. The presence of those scan agents, which are not opted in, may still affect the way counters are incremented since they may end up with a higher duty cycle of scanning by requiring scan parameters with a higher duty cycle than any other scan agents. The threshold values may be recomputed and reapplied only when a scan agent in need of dynamic scan duration starts or stops scanning.

Each scan agent may have a set of required threshold values. For the scan agent i using discovery scan, the threshold values may include:
Req_Discovery_Total_i={Required Total Amount of Discovery Scan Time for scan agent i}
Req_Discovery_CoreA_i={Required Amount of Discovery Scan Time on Core A for scan agent i}
Req_Discovery_CoreB_i={Required Amount of Discovery Scan Time on Core B for scan agent i}

If any of them (total, CoreA, or CoreB) has issues compromising its fidelity, it can be set to a value indicating to be ignored (nil).

For the scan agent i using connection scan, the threshold values may include:
Req_Connection_Total_i={Required Total Amount of Connection Scan Time for scan agent i}
Req_Connection_CoreA_i={Required Amount of Connection Scan Time on Core A for scan agent i}
Req_Connection_CoreA_i={Required Amount of Connection Scan Time on Core B for scan agent i}

At any moment, for each opted-in scan agent, the following counters for each scan agent may be tracked at any moment while this scan agent is scanning. For the scan agent i using discovery scan, the following counters may be tracked:
Remaining_Discovery_Total_i={Remaining Total Amount of Discovery Scan Time for scan agent i}
Remaining_Discovery_CoreA_i={Remaining Amount of Discovery Scan Time on Core A for scan agent i}
Remaining_Discovery_CoreB_i={Remaining Amount of Discovery Scan Time on Core B for scan agent i}

For the scan agent i using connection scan, the following counters may be tracked:
Remaining_Connection_Total_i={Remaining Total Amount of Connection Scan Time for scan agent i}
Remaining_Connection_CoreA_i={Remaining Amount of Connection Scan Time on Core A for scan agent i}
Remaining_Connection_CoreB_i={Remaining Amount of Connection Scan Time on Core B for scan agent i}

The scanner may track the scanner-level statistics such as:
Achieved_Discovery_Total={Achieved Total Amount of Discovery Scan Time}
Achieved_Discovery_CoreA={Achieved Amount of Discovery Scan Time on Core A}
Achieved_Discovery_CoreB={Achieved Amount of Discovery Scan Time on Core B}
Achieved_Connection_Total={Achieved Total Amount of Connection Scan Time}
Achieved_Connection_CoreA={Achieved Amount of Connection Scan Time on Core A}
Achieved_Connection_CoreB={Achieved Amount of Connection Scan Time on Core B}

In sum, each scan agent may have requirements for a scan agent, as well as current statistics (achieved amount of scanning time), such as: Remaining amount of scan time at a moment is computed by requirements and current statistics. For example, {Remaining Total Amount of Discovery Scan Time}={Required Total Amount of Discovery Scan Time}−{Achieved Total Amount of Discovery Scan Time}.

At the scanner, the threshold values may be configured by combining all requirements and/or current statistics of scan agents in need of dynamic scan duration. The scanner may also track each statistics/counters at the scanner level by tracking the remaining amount of scan time for each combination of scanning type and core. In the simplest case where we have only one scan agent i in need of dynamic scan duration control, the workflow may be as follows if this scan agent is doing discovery scanning only.

Block 1. Threshold values may be configured based on the requirement and configure on the scanner.
Threshold_Discovery_Total=Req_Discovery_Total_i
Threshold_Discovery_CoreA=Req_Discovery_CoreA_i
Threshold_Discovery_CoreB=Req_Discovery_CoreB_i
Threshold_Connection_Total=nil
Threshold_Connection_CoreA=nil
Threshold_Connection_CoreB=nil

Since this scan agent only executes discovery scanning, threshold values for connection scanning may be set to a value indicating that the thresholds are to be ignored (in this disclosure, threshold values with nil may be ignored).

Block 2. The scanner may continue to update the statistics/counters.

Block 3. Once at least one of the threshold value is met, i.e. any of the following conditions is met:
Achieved_Discovery_Total>=Threshold_Discovery_Total, or
Achieved_Discovery_CoreA>=Threshold_Discovery_CoreA, or
Achieved_Discovery_CoreB>=Threshold_Discovery_CoreB

The whole set of achieved time may be reported.

Block 4. The scanning for Scan Agent i may be terminated.

In more complicated cases where there are multiple scan agents and each scan agent may be using a different type of scanning, the workflow may be as follows. At starting or stopping of scanning for a scan agent in need of dynamic scan duration control, the following procedure may be initiated. Assume there are N scan agents, and each of them is identified by a number in {1, 2, . . . , N}.

Block 1. Threshold values may be configured based on the requirement and remaining scan time from all scan agents and threshold values may be configured on the Scanner. The threshold values may be computed as follows:
Threshold_Discovery_Total=min (Remaining_Discovery_Total_1, Remaining_Discovery_Total_2, . . . , Remaining_Discovery_Total_N)
Threshold_Discovery_CoreA==min (Remaining_Discovery_CoreA_1, Remaining_Discovery_CoreA_2, . . . , Remaining_Discovery_CoreA_N)
Threshold_Discovery_CoreB==min (Remaining_Discovery_CoreB_1,
Remaining_Discovery_CoreB 2, . . . , Remaining_Discovery_CoreB_N)
Threshold_Connection_Total=min (Remaining_Connection_Total_1, Remaining_Connection_Total_2, . . . , Remaining_Connection_Total_N)
Threshold_Connection_CoreA==min (Remaining_Connection_CoreA_1, Remaining_Connection_CoreA_2, . . . , Remaining_Connection_CoreA_N)
Threshold_Connection_CoreB==min (Remaining_Connection_CoreB_1, Remaining_Connection_CoreB_2, . . . , Remaining_Connection_CoreB_N)

When scanning starts for a scan agent for the first time, remaining time may be the same as required time, e.g., Remaining_Discovery_Total_i=Req_Discovery_Total_i, and so forth.

Block 2. Scanner may continue to update the statistics/counters.

Block 3. Once at least one of the threshold value is met, i.e. any of the following conditions is met,
Achieved_Discovery_Total>=Threshold_Discovery_Total, or
Achieved_Discovery_CoreA>=Threshold_Connection_CoreA, or
Achieved_Discovery_CoreB>=Threshold_Discovery_CoreB, or
Achieved_Connection_Total>=Threshold_Connection_Total, or
Achieved_Connection_CoreA>=Threshold_Connection_CoreA, or
Achieved_Connection_CoreB>=Threshold_Connection_CoreB

The whole set of achieved time may be reported.

Block 4. The remaining scan time may be recomputed for each scan agent, e.g., for scan agent i performing discovery scan, the remaining scan times to be recomputed may include:
Remaining_Discovery_Total_i=Remaining_Discovery_Total_i
Achieved_Discovery_Total
Remaining_Discovery_CoreA_i=Remaining_Discovery_CoreA_i
Achieved_Discovery_CoreA
Remaining_Discovery_CoreB_i=Remaining_Discovery_CoreB_i
Achieved_Discovery_CoreB
Remaining_Discovery_Total_i=Remaining_Discovery_Total_i
Achieved_Discovery_Total
Remaining_Discovery_CoreA_i=Remaining_Discovery_CoreA_i
Achieved_Discovery_CoreA
Remaining_Discovery_CoreB_i=Remaining_Discovery_CoreB_i
Achieved_Discovery_CoreB

For scan agent j performing connection scan, the remaining scan times to be recomputed may include:
Remajning_Connection_Total_j=Remaining_Connection_Total_j
Achieved_Connection_Total
Remaining_Connection_Corekj=Remaining_Connection_CoreA_j
Achieved_Connection_CoreA
Remaining_Connection_CoreB_j=Remaining_Connection_CoreB_j
Achieved_Connection_CoreB
Remaining_Connection_Total_j=Remaining_Connection_Total_j
Achieved_Connection_Total
Remaining_Connection_CoreA_j=Remaining_Connection_CoreA_j
Achieved_Connection_CoreA
Remaining_Connection_CoreB_j=Remaining_Connection_CoreB_j
Achieved_Connection_CoreB

Block 5. The scanning may be terminated for any scan agent with at least one remaining scan time reaches zero. If any scan agent has at least one remaining scan time reaches zero, the scanning for this scan agent is completed.

Block 6. If there is at least one scan agent which scanning not terminated, start from block 1.

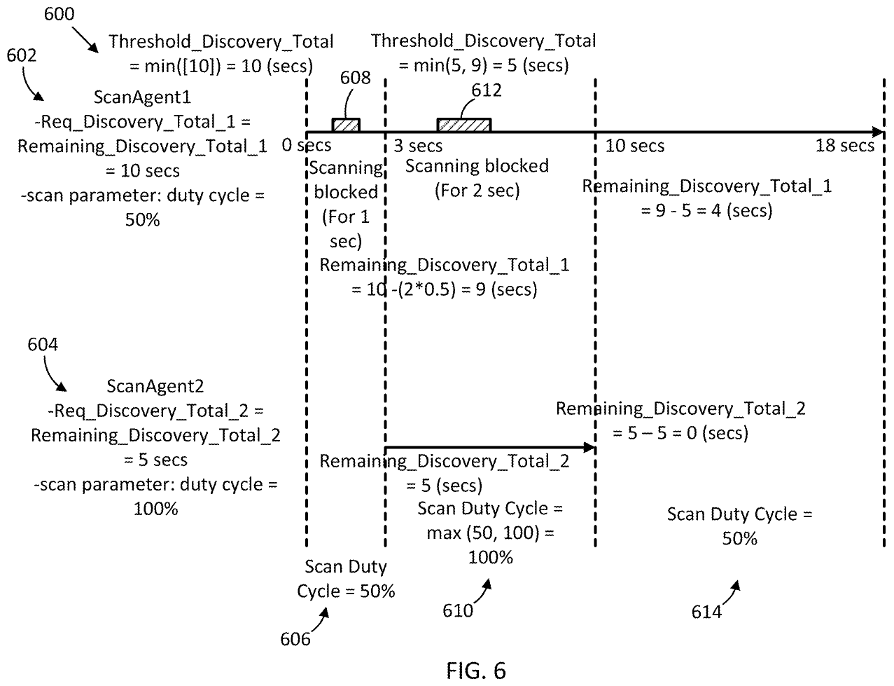

FIG. 6 illustrates an example scan representation 600 for multiple scan agents in accordance with some embodiments. For example, FIG. 6 shows an example where two scan agents are doing scanning with dynamic scan duration control for the same type of scanning (discovery scanning) but with a different requirement and scan parameters. It is assumed that when multiple scan agents are doing scanning together, the combined scan parameter may be the scan parameter of a scan agent with the highest duty cycle. For example, when a scanner has scan operations requested at a same time by multiple scan agents, the scanner may proceed with scanning with a highest duty cycle of the duty cycles for the scan operations.

The scan representation 600 illustrates an example scan performed for a first scan operation requested by a first scan agent 602 (which may be referred to as ScanAgent1) and a second scan operation requested by a second scan agent 604 (which may be referred to as ScanAgent2). Each of the scan agents may define scan parameters for the scan operations being requested by the scan agents. For example, the first scan agent 602 may define scan parameters for scan operations requested by the first scan agent 602, including the first scan operation. In the illustrated embodiment, the first scan agent 602 defines the first scan operation for a discovery capture time of 10 seconds, a duty cycle of 50%, and a relative initiation scan time of 0 seconds. The second scan agent 604 may define scan parameters for scan operations requested by the second scan agent 604, including the second scan operation. In the illustrated embodiment, the second scan agent 604 defines the second scan operation for a discovery capture time of 5 seconds, a duty cycle of 100%, and a relative initiation scan time of 3 seconds.

The scanner may initiate a scan for the first scan operation and the second scan operation. At the start and/or stop of each scan operation, the scanner may determine a remaining time for each of the scan operations being served. At the initiation of the scan, the scan operation being served may be only the first scan operation in the illustrated embodiment. Accordingly, the scanner may determine the remaining time for the first scan operation. The scanner may determine the remaining time by subtracting the scanning time completed for the scan operation from the requested capture time for the scan operation. As the requested scan time for the first scan operation is 10 seconds and no scanning time has been completed for the first scan operation, the scanner may determine that 10 seconds is the remaining time for the first scan operation. In some embodiments, the scanner may set a remaining scan counter for the first scan operation to 10 seconds, where the counter is to count as scanning for packets is being performed (for example, the counter may count when the scanner is seeking packets (for example, performing active scanning) based on the duty cycle of the scan, and may stop counting when the scanner has stopped seeking packets based on the duty cycle of the scan and/or when the device identifies interference).

Additionally, the scanner may determine a duty cycle for the scan at the start and/or stop of each scan operation based on the duty cycles for each of the scan operations being served going forward. In particular, scanner may determine the duty cycle going forward to be the highest duty cycle of scan operations being served after the determination. At the initiation, the first scan operation may be the only scan operation going forward. Since the first scan operation is the only scan operation being served going forward, the scanner may determine that a duty cycle of 50% is to be utilized starting at the initiation of the scan.

For description purposes, the scan may be broken up into multiple portions. The scan may have a first portion 606 that extends from 0 seconds to 3 seconds. The scanner may implement a duty cycle of 50% for the scan based on the determination at the initiation of the scan.

The device may identify a first interruption 608 during the first portion 606 of the scan. The duration of the first interruption 608 may be 1 second. The device may take into account the interruptions and/or durations of the interruptions when determining the scanning time completed, as described further for this example.

At three seconds, the second scan operation requested by the second scan agent 604 may be started. Based on the second scan operation being started, the scanner may determine the remaining scanning time for both the first scan operation and the second scan operation. The scanner may determine that 2 seconds were available for the scan without interruption during the first portion 606 based on the first interruption 608. Further, the scanner may determine that 1 second of scanning has been completed based on the duty cycle of the scan being 50% for the first portion 606 of the scan. As 1 second of scanning has been determined to be completed for the first scan operation and the requested scanning time of 10 seconds, the scanner may determine that the first scan operation has a remaining scanning time of 9 seconds remaining at 3 seconds of the scan. In some embodiments, the scanner may reset the remaining scan counter to the value determined remaining when a scan operation starts and/or stops. For example, the scanner may reset the remaining scan counter for the first scan operation to 9 seconds based on the determination.

For the second scan operation requested by the second scan agent 604, the scanner may determine that no scanning has been completed for the second scan operation as the second scan operation is just being initiated. As the initial scan time requested for the second scan operation is 5 seconds, the scanner may determine that the remaining scan time for the second scan operation is 5 seconds. In some embodiments, the scanner may set a second remaining scan counter for the second scan operation to 5 seconds.

The scanner may determine a duty cycle going forward from the 3 seconds based on the second scan operation being initiated. As the first scan operation and the second scan operation are both being served going forward from the 3 second time, the scanner may determine the duty cycle going forward from the 3 second time to be the higher duty cycle of the duty cycles for the first scan operation and the second scan operation. In the illustrated embodiment, the scanner may determine to proceed from the 3 second time with a duty cycle of 100% based on the duty cycle of 100% for the second scan operation being higher than the 50% duty cycle for the first scan operation.

The scan may proceed with a second portion 610 of the scan from 3 seconds to 10 seconds. The scanner may utilize a duty cycle of 100% for the scanning during the second portion 610. The device may identify a second interference 612 during the second portion 610. The second interference 612 may have a duration of 2 seconds. The scanner may determine that 5 seconds of scanning has been completed for the first scan operation and the second scan operation during the second portion 610 of the scan based on 5 seconds of the second portion 610 being available for scanning without interference and the duty cycle of the scanning being 100%. As the second scan operation requested by the second scan agent 604 had a remaining discovery time of 5 seconds at the beginning of the second portion of the scan, the scanner may determine that the second scan operation has been completed at 10 seconds based on the 5 seconds being available for scanning without interference by 10 seconds of the scan and the duty cycle of 100% during the second portion 610 of the scan. Accordingly, the scanner and/or the second scan agent 604 may determine to stop the second scan operation at 10 seconds based on the scanning time for the second scan operation being fulfilled. In some embodiments, the scanner and/or the second scan agent 604 may determine to stop the second scan operation based on the second remaining scan counter corresponding to the second scan operation expiring.

With the second scan operation being stopped at 10 seconds, the scanner may determine the remaining scan times for the scan operations being served after the stoppage and/or the duty cycle to be utilized for the scan after the stoppage. In the illustrated embodiment, the scanner may only be serving the first scan operation requested by the first scan agent 602 after 10 seconds. Accordingly, the scanner may determine the remaining scan time only for the first scan operation in the illustrated embodiment. The scanner may determine that 5 seconds of scanning has been successfully captured for the first scan operation based on there being 5 seconds of the scan available without interruptions during the second portion 610 of the scan and the duty cycle during the second portion 610 being 100%. As the initial requested scan time for the first scan operation was 10 seconds, 1 second of scanning was successfully captured during the first portion 606 for the first scan operation, and 5 seconds of scanning was successfully captured during the second portion 610 for the first scan operation, the scanner may determine that there is 4 seconds remaining scan time for the first scan operation at 10 seconds of the scan. In some embodiments, the scanner may reset the remaining scan counter for the first scan operation to 4 seconds based on the determination.

The scanner may determine a duty cycle going forward from the 10 seconds based on the second scan operation being stopped. As the first scan operation is the only scan operation being served going forward from the 10 second time, the scanner may determine the duty cycle going forward from the 3 second time to be the duty cycle of the first scan operation. In the illustrated embodiment, the scanner may determine to proceed from the 10 second time with a duty cycle of 50% based on the 50% duty cycle for the first scan operation.

The scan may proceed with a third portion 614 of the scan from 10 seconds to 18 seconds. The scanner may utilize a duty cycle of 50% for the scanning during the third portion 614. The scanner may determine that 4 seconds of scanning has been completed for the first scan operation during the third portion 614 of the scan based on 8 seconds of the third portion 614 being available for scanning without interference and the duty cycle of the scanning being 50%. As the first scan operation requested by the first scan agent 602 had a remaining discovery time of 4 seconds at the beginning of the second portion of the scan, the scanner may determine that the first scan operation has been completed at 18 seconds based on the 8 seconds being available for scanning without interference by 18 seconds of the scan and the duty cycle of 50% during the third portion 614 of the scan. Accordingly, the scanner and/or the first scan agent 602 may determine to stop the first scan operation at 18 seconds based on the scanning time for the first scan operation being fulfilled. In some embodiments, the scanner and/or the first scan agent 602 may determine to stop the first scan operation based on the remaining scan counter corresponding to the first scan operation expiring. As both the first scan operation and the second scan operation have been fulfilled and there are no other scan operations to be performed in the illustrated embodiment, the scanner may terminate the scan.

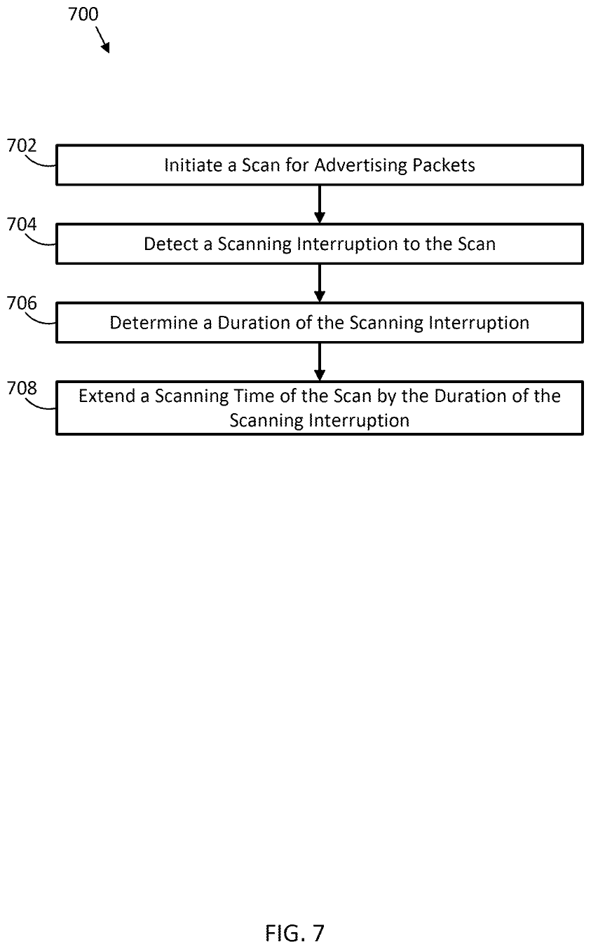

FIG. 7 illustrates an example procedure 700 for a scan in accordance with some embodiments. The procedure 700 may be performed by a device. In particular, the operations described within the procedure 700 may be performed by scan agents of the device, a scanner of the device, or some combination thereof. The procedure 700 may be performed for a single scan operation requested by a single scan agent or for multiple scan operations requested by multiple scan agents in embodiments.

In 702, the device may initiate a scan for advertising packets. For example, the device may initiate a scan for advertising packets transmitted by one or more advertising devices.

In some embodiments, the procedure 700 may further include determining a duty cycle for the scan at initiation. In embodiments where a single scan operation is being started at the initiation, the device may determine the duty cycle for the scan to be the duty cycle of the single scan operation.

In embodiments where multiple scan operations are being started at the initiation, the device may determine the duty cycle for the scan to be the highest duty cycle from the duty cycles of the multiple scan operations. For example, the scan may be performed for a first scan operation for a first scan agent and a second scan operation for a second scan agent in some embodiments. Further, the first scan operation may have a first duty cycle and the second scan operation may have a second duty cycle. The device may determine which of the first duty cycle or the second duty cycle is a higher duty cycle. The scan may implement the higher duty cycle of the first duty cycle or the second duty cycle. In some embodiments, the device may utilize the first duty cycle for a first portion of the scan and the device may utilize the second duty cycle for a second portion of the scan.

In some embodiments, the device may redetermine the duty cycle to be utilized for the scan each time that a scan operation starts and/or each time that a scan operation stops. For example, the device may redetermine the duty cycle for a scan each time that a scan operation starts and/or stops, where the duty cycle for the scan may be determined based on the duty cycles for the scan operations to be served after the scan operation starts and/or stops. In some embodiments, the redetermination of the duty cycle can cause the duty cycle of the scan to change during the scan.

In some embodiments, the device may determine remaining scan times for the scan operations requested by the scan agents. For example, the device may subtract a value for the successful scanning time for a scan operation from a threshold value for a remaining scan time for the scan operation to recompute the threshold value for the remaining scan time. In some embodiments, the device may recompute a threshold value for a remaining scan time for a second scan operation based at least in part on a first scan operation being started or stopped.

In some embodiments, the device may determine an initial value for a scanning time of the scan. The initial value for the scanning time may define an original scan duration for the scan without any interference. The scanning time may be dynamically changed as interference occurs. In some embodiments, the initial value for the scanning time of the scan may be determined based on scan parameters for a scan operation for a scan agent, such as a duration for the scan operation, a duty cycle for the scan operation, or some combination thereof. In the instance where multiple scan operations for one or more scan agents are to be initiated at the initiation of the scan, the initial for the scanning time of the scan may be determined based on scan parameters of one or more of the scan operations. For example, the scan may be performed for a first scan operation for a first scan agent and a second scan operation for a second scan agent in some embodiments, wherein the scanning time of the scan may be determined based at least in part on the first scan operation and the second scan operation.

In 704, the device may detect a scanning interruption to the scan. The scanning interruption may be one or more of the interruptions described throughout this disclosure, such as the coexistence conditions affecting the scan performance and/or other Bluetooth/Wi-Fi operations affecting the scanning performance. In some embodiments, the scan may be performed within a frequency range. In some of these embodiments, the scanning interruption may include one or more unrelated transmissions transmitted within the frequency range of the scan.

In 706, the device may determine a duration of the scanning interruption. In particular, the device may determine a duration of the scanning interruption detected in 704. In some embodiments, determining the duration of the scanning interruption may include identifying a start of the scanning interruption and stopping one or more counters for scan operations based on the start of the scanning interruption, and identifying a stop of the scanning interruption and restarting the one or more counters for scan operations based on the stop of the scanning interruption. In other embodiments, the device may maintain a timer and/or counter to determine the duration of the scanning interruption.

In 708, the device may extend a scanning time of the scan based on the duration of the scanning interruption determined in 706. Accordingly, the duration of the scanning interruption may extend the scanning time of the scan by an amount determined based on the duration of the scanning interruption. The extension of the scanning time may be performed dynamically as the scan is being performed and as the scanning interruption occurs. Accordingly, the device may determine an actual duration of the scanning interruption rather than estimating a duration of the scanning interruption prior to initiating the scan.

In some embodiments, extending the scanning time of the scan may include stopping a counter corresponding to the scanning time of the scan upon detection of the scanning interruption and restarting the counter at a completion of the scanning interruption. In instances where the scan is being performed with multiple scan operations and multiple counters are being maintained for the multiple scan operations, extending the scanning time of the scan may include stopping the multiple counters upon detection of the scanning interruption and restarting the multiple counters at a completion of the scanning interruption.

In some embodiments, extending the scanning time of the scan may include adding the duration of the scanning interruption to an initial value for the scanning time. For example, an initial value for the scanning time of the scan may be determined based on scan parameters for a scan operation for a scan agent. In instances where multiple scan operations are being performed, an initial value for the scanning time of the scan may be determined based on scan parameters for one or more of the multiple scan operations. Extending the scanning time of the scan may include extending the scanning time to be the initial value for the scanning time plus the duration of the scanning interruption.

Extending the scanning time based on the duration of the scanning interruption (as described in relation to the procedure 700 and throughout this disclosure) may avoid the over-compensation and the under-compensation presented by legacy approaches of addressing scanning interruption. Accordingly, the extending the scanning time may be more efficient with the use of resources and/or power usage than legacy approaches.

While FIG. 7 may arguably imply an order of the operations of the procedure 700, it should be understood that one or more of the operations may be performed in a different order and/or one or more of the operations may be performed concurrently in embodiments. Further, it should be understood that one or more of the operations may omitted from the procedure 700 and/or one or more additional operations may be added to the procedure 700 in embodiments.

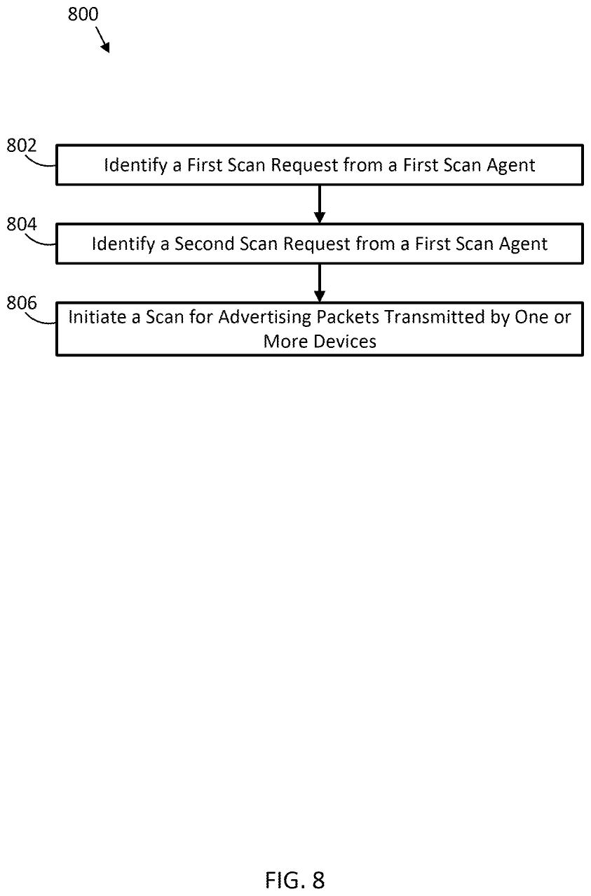

FIG. 8 illustrates an example procedure 800 for a scan in accordance with some embodiments. The procedure 800 may be performed by a device. In particular, the operations described within the procedure 800 may be performed by scan agents of the device, a scanner of the device, or some combination thereof. The procedure 800 may be performed for multiple scan operations requested by one or more scan agents in embodiments.

In 802, the device may identify a first scan request from a first scan agent. For example, the device may identify a first scan request from a first scan agent of the device. The first scan request may define a first scan duration, a first active scanning time, and/or a first duty cycle for a first scan process being requested by the first scan request. The device may determine the first scan duration, the first active scanning time, and/or the first duty cycle for the first scan request.

In 804, the device may identify a second scan request from a second scan agent. For example, the device may identify a second scan request from a second scan agent of the device. The second scan request may define a second scan duration, a second active scanning time, and/or a second duty cycle for a second scan process being request by the second scan request. The device may determine the second scan duration, the second active scanning time, and/or the second duty cycle for the second scan request.

In 806, the device may initiate a scan for advertising packets transmitted by one or more devices. For example, the device may initiate a scan for advertising packets transmitted by one or more devices, wherein the portion of the scan may provide service for both the first scan request and the second scan request. By providing service for both the first scan request and the second scan request, the active scanning performed during the portion of the scan may count to both the first active scanning time for the first scan agent and the second active scanning time for the second scan agent.

In some embodiments, the device may determine a first duty cycle associated with the first scan request. Further, the device may determine a second duty cycle associated with the second scan request. In some of these embodiments, the device may determine which is a higher duty cycle of the first duty cycle and the second duty cycle. The device may utilize the determined higher duty cycle of the first duty cycle and the second duty cycle for the portion of the scan.

In some of the embodiments where the device determines the first duty cycle associated with the first scan request and the second duty cycle associated with the second scan request, the portion of the scan may be a first portion of the scan. In these embodiments, the device may utilize the first duty cycle for the first portion of the scan. Further, the device may utilize the second duty cycle for a second portion of the scan.

In some embodiments, the first scan request may define a first active scanning time. Further, the second scan request may define a second active scanning time. The device may terminate the scan based at least in part on the first active scanning time and the second active scanning time being fulfilled. In some of these embodiments, the first scan may define a scan duration. The device may terminate the scan prior to completion of the scan duration based at least in part on the portion of the scan providing service for both the first scan request and the second scan request.

In some embodiments, the device may start a timer for the first scan request at initiation of the scan, the timer corresponding to an active scanning time for the first scan request. Further, the device may detect a scanning interruption to the scan. The device may stop the timer upon detection of the scanning interruption. Further, the device may restart the time at a completion of the scanning interruption.

In some of the embodiments where the device detects the scanning interruption, the timer may be a first timer and the active scanning time may be a first active scanning time. The scanning interruption may be detected during the portion of the scan. The device may stop a second timer for the second scan request upon detection of the scanning interruption, the second timer corresponding to a second active scanning time for the second scan request. Further, the device may restart the second timer at the completion of the scanning interruption.

While FIG. 8 may arguably imply an order of the operations of the procedure 800, it should be understood that one or more of the operations may be performed in a different order and/or one or more of the operations may be performed concurrently in embodiments. Further, it should be understood that one or more of the operations may omitted from the procedure 800 and/or one or more additional operations may be added to the procedure 800 in embodiments.

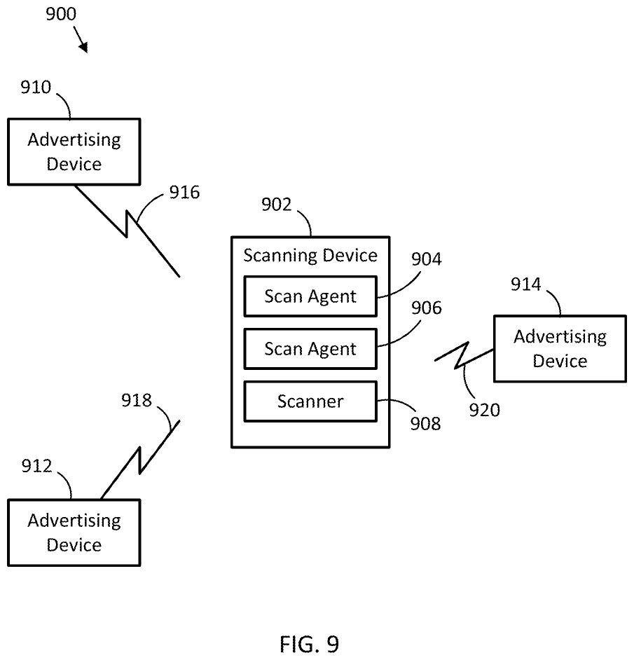

FIG. 9 illustrates an example system arrangement 900 in accordance with some embodiments. In particular, the system arrangement 900 may illustrate part of a system that may support and/or implement the approaches described throughout this disclosure. Elements within the system arrangement 900 may include one or more of the features described throughout this disclosure.

The system arrangement 900 may include one or more scanning devices. In the illustrated embodiment, the system arrangement 900 includes a scanning device 902. The scanning devices may include one or more of the features of the scanning devices described throughout this disclosure. The scanning devices may, at the time, be configured to scan for advertising packets. For example, the scanning device 902 may be configured to scan for advertising packets for discovering other devices within the vicinity of the scanning device 902 and/or for establishing connections with other devices with the vicinity of the scanning device 902.

The scanning devices may include one or more scan agents. For example, the scanning device 902 includes a first scan agent 904 and a second scan agent 906 in the illustrated embodiment. Each of the scan agents may include one or more of the features of the scan agents described throughout this disclosure. The scan agents may request one or more scan operations to be performed by the scanning device, such as discovery scan operations and/or connection scan operations.

The scanning devices may include one or more scanners. For example, the scanning device 902 includes a scanner 908. Each of the scanners may include one or more of the features of the scanners described throughout this disclosure. The scanners may receive the requests for scan operations from the scan agents and perform scans for the scan agents. For example, the scanners may scan for advertising packets to fulfill the scan operations. The scanners may perform the scan in accordance with the scans described throughout this disclosure.

The system arrangement 900 may include one or more advertising devices. In the illustrated embodiment, the system arrangement 900 includes a first advertising device 910, a second advertising device 912, and a third advertising device 914. Each of the advertising devices may transmit (such as via broadcast and/or multicast) advertising packets. For example, the first advertising device 910 may transmit first advertising packets 916, the second advertising device 912 may transmit second advertising packets 918, and the third advertising device 914 may transmit third advertising packets 920 in the illustrated embodiment. The advertising packets may include information related to the corresponding advertising device. The advertising devices may, at the time, be configured to transmit the advertising packets.

The scanning devices may scan for the advertising packets transmitted by the advertising devices. For example, the scanning device 902 may scan for the first advertising packets 916 transmitted by the first advertising device 910, the second advertising packets 918 transmitted by the second advertising device 912, and/or the third advertising packets 920 transmitted by the third advertising device 914 in the illustrated embodiment. The scanning device 902 may utilize the information from the received advertising packets to discover the corresponding advertising devices and/or connect to the corresponding advertising devices.

It should be understood that the scanning devices and the advertising devices may include the same features in some embodiments. For example, the scanning devices and the advertising devices may include the same hardware (or similar hardware) and/or the same software (or similar software) in some embodiments. The difference between the scanning devices and the advertising devices may be in that the scanning devices have been configured to perform scans and the advertising devices have been configured to transmit advertising packets. The configuration of scanning and advertising may be changed at different times, such that a device may act as a scanning device when configured to perform scans and may act as an advertising device when configured to transmit advertising packets.

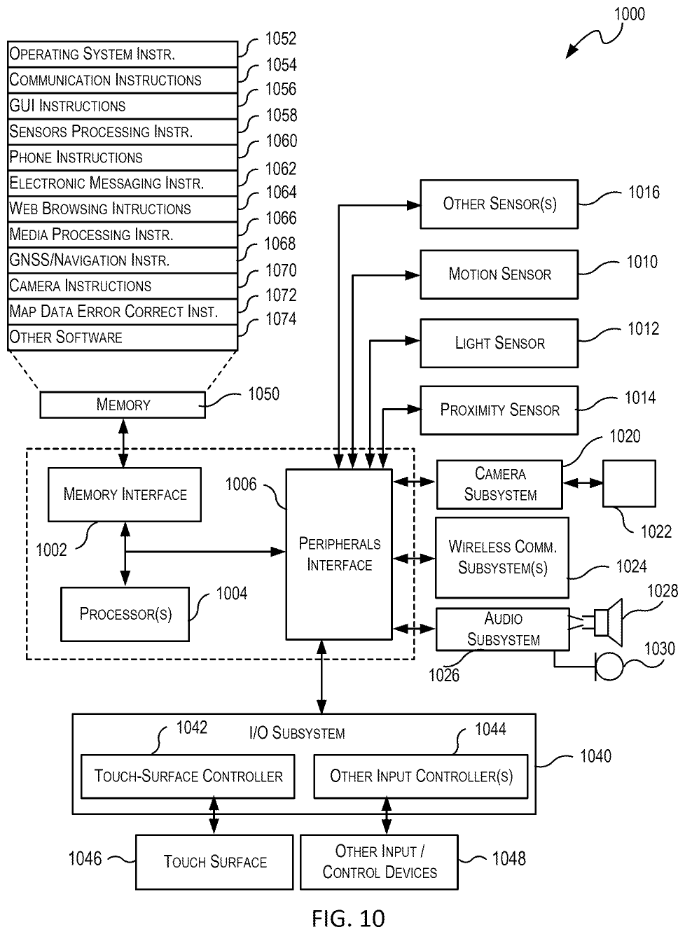

FIG. 10 is a block diagram of an example computing device 1000 that can implement the features and processes of FIGS. 1-9 in accordance with some embodiments. The computing device 1000 may be an example of the scanning device 902 (FIG. 9), the first advertising device 910 (FIG. 9), the second advertising device 912 (FIG. 9), and/or the third advertising device 914 (FIG. 9). The computing device 1000 can include a memory interface 1002, one or more data processors, image processors and/or central processing units 1004, and a peripherals interface 1006. The memory interface 1002, the one or more processors 1004 and/or the peripherals interface 1006 can be separate components or can be integrated in one or more integrated circuits. The various components in the computing device 1000 can be coupled by one or more communication buses or signal lines.

Sensors, devices, and subsystems can be coupled to the peripherals interface 1006 to facilitate multiple functionalities. For example, a motion sensor 1010, a light sensor 1012, and a proximity sensor 1014 can be coupled to the peripherals interface 1006 to facilitate orientation, lighting, and proximity functions. Other sensors 1016 can also be connected to the peripherals interface 1006, such as a global navigation satellite system (GNSS) (e.g., GPS receiver), a temperature sensor, a biometric sensor, magnetometer or other sensing device, to facilitate related functionalities.

A camera subsystem 1020 and an optical sensor 1022 (e.g., a charged coupled device (CCD) or a complementary metal-oxide semiconductor (CMOS) optical sensor) can be utilized to facilitate camera functions, such as recording photographs and video clips. The camera subsystem 1020 and the optical sensor 1022 can be used to collect images of a user to be used during authentication of a user (e.g., by performing facial recognition analysis).

Communication functions can be facilitated through one or more wireless communication subsystems 1024, which can include radio frequency receivers and transmitters and/or optical (e.g., infrared) receivers and transmitters. The specific design and implementation of the communication subsystem 1024 can depend on the communication network(s) over which the computing device 1000 is intended to operate. For example, the computing device 1000 can include communication subsystems 1024 designed to operate over a GSM network, a GPRS network, an EDGE network, a Wi-Fi or WiMax network, and a Bluetooth™ network. The wireless communication subsystems 1024 may be utilized for and/or may facilitate the scanning described throughout this disclosure. For example, the wireless communication subsystems 1024 may be included in and/or may implement a scanner as described throughout this disclosure.

An audio subsystem 1026 can be coupled to a speaker 1028 and a microphone 1030 to facilitate voice-enabled functions, such as speaker recognition, voice replication, digital recording, and telephony functions. The audio subsystem 3426 can be configured to facilitate processing voice commands, voice printing and voice authentication, for example.

The I/O subsystem 1040 can include a touch-surface controller 1042 and/or other input controller(s) 1044. The touch-surface controller 1042 can be coupled to a touch surface 1046. The touch surface 1046 and touch-surface controller 1042 can, for example, detect contact and movement or break thereof using any of a plurality of touch sensitivity technologies, including, but not limited to, capacitive, resistive, infrared, and surface acoustic wave technologies, as well as other proximity sensor arrays or other elements for determining one or more points of contact with the touch surface 1046.

The other input controller(s) 1044 can be coupled to other input/control devices 1048, such as one or more buttons, rocker switches, thumbwheel, infrared port, USB port, and/or a pointer device such as a stylus. The one or more buttons (not shown) can include an up/down button for volume control of the speaker 1028 and/or the microphone 1030.

In one implementation, a pressing of the button for a first duration can disengage a lock of the touch surface 1046; and a pressing of the button for a second duration that is longer than the first duration can turn power to the computing device 1000 on or off. Pressing the button for a third duration can activate a voice control, or voice command, module that enables the user to speak commands into the microphone 1030 to cause the device to execute the spoken command. The user can customize a functionality of one or more of the buttons. The touch surface 1046 can, for example, also be used to implement virtual or soft buttons and/or a keyboard.

In some examples, the computing device 1000 can present recorded audio and/or video files, such as MP3, AAC, and MPEG files. In some examples, the computing device 1000 can include the functionality of an MP3 player, such as an iPod™.

The memory interface 1002 can be coupled to memory 1050. The memory 1050 can include high-speed random-access memory and/or non-volatile memory, such as one or more magnetic disk storage devices, one or more optical storage devices, and/or flash memory (e.g., NAND, NOR). The memory 1050 can store an operating system 3452, such as Darwin, RTXC, LINUX, UNIX, OS X, WINDOWS, or an embedded operating system such as VxWorks.

The operating system 1052 can include instructions for handling basic system services and for performing hardware dependent tasks. In some examples, the operating system 1052 can be a kernel (e.g., UNIX kernel). In some examples, the operating system 1052 can include instructions for performing map data error correction. For example, operating system 1052 can implement the scanning features as described with reference to FIGS. 1-9.

The memory 1050 can also store communication instructions 1054 to facilitate communicating with one or more additional devices, one or more computers and/or one or more servers. The memory 1050 can include graphical user interface instructions 1056 to facilitate graphic user interface processing; sensor processing instructions 1058 to facilitate sensor-related processing and functions; phone instructions 1060 to facilitate phone-related processes and functions; electronic messaging instructions 1062 to facilitate electronic-messaging related processes and functions; web browsing instructions 1064 to facilitate web browsing-related processes and functions; media processing instructions 1066 to facilitate media processing-related processes and functions; GNSS/Navigation instructions 1068 to facilitate GNSS and navigation-related processes and instructions; and/or camera instructions 1070 to facilitate camera-related processes and functions.

The memory 1050 can store software instructions 1072 to facilitate other processes and functions, such as the scanning processes and functions as described with reference to FIGS. 1-9. Further, the software instructions 1072 may include instructions to implement the scan agents and/or the scanners as described throughout this disclosure.

The memory 1050 can also store other software instructions 1074, such as web video instructions to facilitate web video-related processes and functions; and/or web shopping instructions to facilitate web shopping-related processes and functions. In some examples, the media processing instructions 1066 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 1050 can include additional instructions or fewer instructions. Furthermore, various functions of the computing device 1000 can be implemented in hardware and/or in software, including in one or more signal processing and/or application specific integrated circuits.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In some examples, “circuitry” can refer to, be part of, or include hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or,” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The specific details of particular embodiments may be combined in any suitable manner or varied from those shown and described herein without departing from the spirit and scope of embodiments of the described techniques.

The above description of example embodiments of the described techniques has been presented for the purposes of illustration and description. It is not intended to be exhaustive or to limit the described techniques to the precise form described, and many modifications and variations are possible in light of the teaching above. The embodiments were chosen and described in order to best explain the principles of the described techniques and its practical applications to thereby enable others skilled in the art to best utilize the described techniques in various embodiments and with various modifications as are suited to the particular use contemplated.

All publications, patents, and patent applications cited herein are hereby incorporated by reference in their entirety for all purposes.

### EXAMPLES

In the following sections, further example embodiments are provided.

Example 1 may include one or more non-transitory computer-readable media having instructions that, when executed by one or more processors of a device, configure the device to initiate a scan for advertising packets associated with one or more advertising devices, wherein the scan has a corresponding scan duration, detect a scanning interruption during the scan, determine a duration of the scanning interruption, and extend the scan duration based at least in part on the duration of the scanning interruption.

Example 2 may include the one or more non-transitory computer-readable media of example 1, wherein to extend the scan duration includes to stop a counter corresponding to a scanning time upon detection of the scanning interruption, and restart the counter at an end of the scanning interruption.

Example 3 may include the one or more non-transitory computer-readable media of example 1, wherein an initial value for the scan duration is determined based on one or more scan parameters, and wherein to extend the scan duration comprises extending the scan duration based on the duration of the scanning interruption.

Example 4 may include the one or more non-transitory computer-readable media of example 1, wherein the scan is to be performed within a frequency range and the scanning interruption comprises an unrelated transmission in the frequency range.

Example 5 may include the one or more non-transitory computer-readable media of example 1, wherein the scan comprises a first scan operation for a first scan agent and a second scan operation for a second scan agent, and wherein the scan duration is determined based at least in part on the first scan operation and the second scan operation.

Example 6 may include the one or more non-transitory computer-readable media of example 5, wherein the first scan operation has a first duty cycle, the second scan operation has a second duty cycle, and the instructions, when executed by the one or more processors, further configure the device to perform the scan based on the higher duty cycle of the first duty cycle and the second duty cycle.

Example 7 may include the one or more non-transitory computer-readable media of example 5, wherein the first scan operation has a first duty cycle, the second scan operation has a second duty cycle, and the instructions, when executed by the one or more processors, further configure the device to perform a first portion of the scan in accordance with the first duty cycle and perform a second portion of the scan in accordance with the second duty cycle.

Example 8 may include the one or more non-transitory computer-readable media of example 5, wherein the instructions, when executed by the one or more processors, configure the device to recompute a threshold value for a remaining scan time for the second scan operation based at least in part on the first scan operation being modified.

Example 9 may include a method of performing a scan by a device, comprising initiating, by the device, a scan for one or more advertising packets associated with one or more advertising devices, wherein the scan has a corresponding scan duration, detecting, by the device, a scanning interruption during the scan, determining, by the device, a duration of the scanning interruption, and extending, by the device, the scan duration based at least in part on the duration of the scanning interruption.

Example 10 may include the method of example 9, wherein extending the scan duration comprises stopping a counter corresponding to a scanning time upon detection of the scanning interruption, and restarting the counter at an end of the scanning interruption.

Example 11 may include the method of example 9, wherein an initial value for the scan duration is determined based on one or more scan parameters and extending the scan duration comprises extending the scan duration based on the duration of the scanning interruption.

Example 12 may include the method of example 9, wherein the scan is performed for a first scan operation for a first scan agent and a second scan operation for a second scan agent, and the scan duration is determined based at least in part on the first scan operation and the second scan operation.

Example 13 may include the method of example 12, wherein the first scan operation has a first duty cycle, the second scan operation has a second duty cycle, and the method further comprises performing the scan in accordance with the higher duty cycle of the first duty cycle and the second duty cycle.

Example 14 may include the method of example 12, wherein the first scan operation has a first duty cycle, the second scan operation has a second duty cycle, and the method further comprises performing the scan using the first duty cycle for a first portion of the scan and the second duty cycle for a second portion of the scan.

Example 15 may include the method of example 12, comprising recomputing a threshold value for a remaining scan time for the second scan operation based at least in part on the first scan operation being modified.

Example 16 may include a device, comprising an antenna for performing scanning, and one or more processors coupled to the antenna, the one or more processors configured to initiate a scan for advertising packets associated with one or more advertising devices, wherein the scan has a corresponding scan duration, detect a scanning interruption during the scan, determine a duration of the scanning interruption, and extend the scan duration based at least in part on the duration of the scanning interruption.

Example 17 may include the device of example 16, wherein extending the scan duration comprises stopping a counter corresponding to the scan upon detection of the scanning interruption, and restarting the counter at an end of the scanning interruption.

Example 18 may include the device of example 16, wherein an initial value for the scan duration is determined based on one or more scan parameters and extending the scan duration comprises extending the scan duration based on the duration of the scanning interruption.

Example 19 may include the device of example 16, wherein the scan is to be performed within a frequency range and the scanning interruption comprises an unrelated transmission in the frequency range.

Example 20 may include the device of example 16, wherein the scan is performed for a first scan operation for a first scan agent and a second scan operation for a second scan agent, and the scan duration is determined based at least in part on the first scan operation and the second scan operation.

Example 21 may include one or more non-transitory computer-readable media having instructions that, when executed by one or more processors of a device, configure the device to initiate a scan for advertising packets transmitted by one or more advertising devices, detect a scanning interruption to the scan, determine a duration of the scanning interruption, and extend a scanning time of the scan based at least in part on the duration of the scanning interruption.

Example 22 may include the one or more non-transitory computer-readable media of example 21, wherein to extend the scanning time of the scan includes to stop a counter corresponding to the scanning time upon detection of the scanning interruption, and restart the counter at a completion of the scanning interruption.

Example 23 may include the one or more non-transitory computer-readable media of example 21, wherein an initial value for the scanning time of the scan is determined based on scan parameters for a scan operation for a scan agent, and wherein to extend the scanning time of the scan includes to extend the scanning time to be the initial value plus the duration of the scanning interruption.

Example 24 may include the one or more non-transitory computer-readable media of example 21, wherein the scan is to be performed within a frequency range, and wherein the scanning interruption includes one or more unrelated transmissions transmitted within the frequency range.

Example 25 may include the one or more non-transitory computer-readable media of example 21, wherein the scan is performed for a first scan operation for a first scan agent and a second scan operation for a second scan agent, and wherein the scanning time of the scan is determined based at least in part on the first scan operation and the second scan operation.

Example 26 may include the one or more non-transitory computer-readable media of example 25, wherein the first scan operation has a first duty cycle, wherein the second scan operation has a second duty cycle, and wherein the instructions, when executed by the one or more processors, configure the device to determine which of the first duty cycle or the second duty cycle is a higher duty cycle, wherein the scan implements the higher duty cycle of the first duty cycle or the second duty cycle.

Example 27 may include the one or more non-transitory computer-readable media of example 25, wherein the first scan operation has a first duty cycle, wherein the second scan operation has a second duty cycle, wherein the device utilizes the first duty cycle for a first portion of the scan, and wherein the device utilizes the second duty cycle for a second portion of the scan.

Example 28 may include the one or more non-transitory computer-readable media of example 25, wherein the instructions, when executed by the one or more processors, configure the device to recompute a threshold value for a remaining scan time for the second scan operation based at least in part on the first scan operation being started or stopped.

Example 29 may include a method of performing a scan by a device, comprising initiating, by the device, the scan for advertising packets transmitted by one or more advertising devices, detecting, by the device, a scanning interruption to the scan, determining, by the device, a duration of the scanning interruption, and extending, by the device, a scanning time of the scan based at least in part on the duration of the scanning interruption.

Example 30 may include the method of example 29, wherein extending the scanning time of the scan includes stopping a counter corresponding to the scanning time upon detection of the scanning interruption, and restarting the counter at a completion of the scanning interruption.

Example 31 may include the method of example 29, wherein an initial value for the scanning time of the scan is determined based on scan parameters for a scan operation for a scan agent, and wherein extending the scanning time of the scan includes to extending the scanning time to be the initial value plus the duration of the scanning interruption.

Example 32 may include the method of example 29, wherein the scan is performed for a first scan operation for a first scan agent and a second scan operation for a second scan agent, and wherein the scanning time of the scan is determined based at least in part on the first scan operation and the second scan operation.

Example 33 may include the method of example 32, wherein the first scan operation has a first duty cycle, wherein the second scan operation has a second duty cycle, and wherein the method comprises determining, by the device, which of the first duty cycle or the second duty cycle is a higher duty cycle, wherein the scan implements the higher duty cycle of the first duty cycle or the second duty cycle.

Example 34 may include the method of example 32, wherein the first scan operation has a first duty cycle, wherein the second scan operation has a second duty cycle, wherein the device utilizes the first duty cycle for a first portion of the scan, and wherein the device utilizes the second duty cycle for a second portion of the scan.

Example 35 may include the method of example 32, comprising recomputing a threshold value for a remaining scan time for the second scan operation based at least in part on the first scan operation being started or stopped.

Example 36 may include a device, comprising antenna hardware to be utilized for scanning for other devices, and one or more processors coupled to the antenna hardware, the one or more processors configured to initiate a scan for advertising packets transmitted by one or more advertising devices, detect a scanning interruption to the scan, determine a duration of the scanning interruption, and extend a scanning time of the scan based at least in part on the duration of the scanning interruption.

Example 37 may include the device of example 36, wherein to extend the scanning time of the scan includes to stop a counter corresponding to the scanning time upon detection of the scanning interruption, and restart the counter at a completion of the scanning interruption.

Example 38 may include the device of example 36, wherein an initial value for the scanning time of the scan is determined based on scan parameters for a scan operation for a scan agent, and wherein to extend the scanning time of the scan includes to extend the scanning time to be the initial value plus the duration of the scanning interruption.

Example 39 may include the device of example 36, wherein the scan is to be performed within a frequency range, and wherein the scanning interruption includes one or more unrelated transmissions transmitted within the frequency range.

Example 40 may include the device of example 36, wherein the scan is performed for a first scan operation for a first scan agent and a second scan operation for a second scan agent, and wherein the scanning time of the scan is determined based at least in part on the first scan operation and the second scan operation.

Example 41 may include one or more non-transitory computer-readable media having instructions that, when executed by one or more processors of a device, configure the device to identify a first scan request from a first scan agent of the device, identify a second scan request from a second scan agent of the device, and initiate a scan for advertising packets transmitted by one or more devices, wherein a portion of the scan provides service for both the first scan request and the second scan request.

Example 42 may include the one or more non-transitory computer-readable media of example 41, wherein the instructions, when executed by the one or more processors, configure the device to determine a first duty cycle associated with the first scan request, determine a second duty cycle associated with the second scan request, determine which is a higher duty cycle of the first duty cycle and the second duty cycle, and utilize the determined higher duty cycle of the first duty cycle and the second duty cycle for the portion of the scan.

Example 43 may include the one or more non-transitory computer-readable media of example 41, wherein the portion of the scan is a first portion of the scan, and wherein the instructions, when executed by the one or more processors, configure the device to determine a first duty cycle associated with the first scan request, determine a second duty cycle associated with the second scan request, utilize the first duty cycle for the first portion of the scan, and utilize the second duty cycle for a second portion of the scan.

Example 44 may include the one or more non-transitory computer-readable media of example 41, wherein the first scan request defines a first active scanning time, wherein the second scan request defines a second active scanning time, and wherein the instructions, when executed by the one or more processors, configure the device to terminate the scan based at least in part on the first active scanning time and the second active scanning time being fulfilled.

Example 45 may include the one or more non-transitory computer-readable media of example 44, wherein the first scan request defines a scan duration, and wherein the device is to terminate the scan prior to completion of the scan duration based at least in part on the portion of the scan providing service for both the first scan request and the second scan request.

Example 46 may include the one or more non-transitory computer-readable media of example 41, wherein the instructions, when executed by the one or more processors, configure the device to start a timer for the first scan request at the initiation of the scan, the timer corresponding to an active scanning time for the first scan request, detect a scanning interruption to the scan, stop the timer upon detection of the scanning interruption, and restart the timer at a completion of the scanning interruption.

Example 47 may include the one or more non-transitory computer-readable media of example 46, wherein the timer is a first timer, wherein the active scanning time is a first active scanning time, and wherein the scanning interruption is detected during the portion of the scan, and wherein instructions, when executed by the one or more processors, configure the device to stop a second timer for the second scan request upon detection of the scanning interruption, the second timer corresponding to a second active scanning time for the second scan request, and restart the second timer at the completion of the scanning interruption.

Example 48 may include a method of performing a scan by a device, comprising identifying, by the device, a first scan request from a first scan agent of the device, identifying, by the device, a second scan request from a second scan agent of the device, and initiating, by the device, the scan for advertising packets transmitted by one or more devices, wherein a portion of the scan provides service for both the first scan request and the second scan request.

Example 49 may include the method of example 48, comprising determining, by the device, a first duty cycle associated with the first scan request, determining, by the device, a second duty cycle associated with the second scan request, determining, by the device, which is a higher duty cycle of the first duty cycle and the second duty cycle, and utilizing, by the device, the determined higher duty cycle of the first duty cycle and the second duty cycle for the portion of the scan.

Example 50 may include the method of example 48, wherein the portion of the scan is a first portion of the scan, and wherein the method comprises determining, by the device, a first duty cycle associated with the first scan request, determining, by the device, a second duty cycle associated with the second scan request, utilizing, by the device, the first duty cycle for the first portion of the scan, and utilizing, by the device the second duty cycle for a second portion of the scan.

Example 51 may include the method of example 48, wherein the first scan request defines a first active scanning time, wherein the second scan request defines a second active scanning time, and wherein method comprises terminating the scan based at least in part on the first active scanning time and the second active scanning time being fulfilled.

Example 52 may include the method of example 51, wherein the first scan request defines a scan duration, and wherein the device is to terminate the scan prior to completion of the scan duration based at least in part on the portion of the scan providing service for both the first scan request and the second scan request.

Example 53 may include the method of example 48, comprising starting, by the device, a timer for the first scan request at the initiation of the scan, the timer corresponding to an active scanning time for the first scan request, detecting, by the device, a scanning interruption to the scan, stopping, by the device, the timer upon detection of the scanning interruption, and restarting, by the device, the timer at a completion of the scanning interruption.

Example 54 may include the method of example 53, wherein the timer is a first timer, wherein the active scanning time is a first active scanning time, and wherein the scanning interruption is detected during the portion of the scan, and wherein the method comprises stopping, by the device, a second timer for the second scan request upon detection of the scanning interruption, the second timer corresponding to a second active scanning time for the second scan request, and restarting, by the device, the second timer at the completion of the scanning interruption.

Example 55 may include a device, comprising antenna hardware to be utilized for scanning for other devices, and one or more processors coupled to the antenna hardware, the one or more processors configured to identify a first scan request from a first scan agent of the device, identify a second scan request from a second scan agent of the device, and initiate a scan for advertising packets transmitted by one or more devices, wherein a portion of the scan provides service for both the first scan request and the second scan request.

Example 56 may include the device of example 55, wherein the one or more processors are configured to determine a first duty cycle associated with the first scan request, determine a second duty cycle associated with the second scan request, determine which is a higher duty cycle of the first duty cycle and the second duty cycle, and utilize the determined higher duty cycle of the first duty cycle and the second duty cycle for the portion of the scan.

Example 57 may include the device of example 55, wherein the portion of the scan is a first portion of the scan, and wherein the one or more processors are configured to determine a first duty cycle associated with the first scan request, determine a second duty cycle associated with the second scan request, utilize the first duty cycle for the first portion of the scan, and utilize the second duty cycle for a second portion of the scan.

Example 58 may include the device of example 55, wherein the first scan request defines a first active scanning time, wherein the second scan request defines a second active scanning time, and wherein the one or more processors are configured to terminate the scan based at least in part on the first active scanning time and the second active scanning time being fulfilled.

Example 59 may include the device of example 58, wherein the first scan request defines a scan duration, and wherein the device is to terminate the scan prior to completion of the scan duration based at least in part on the portion of the scan providing service for both the first scan request and the second scan request.

Example 60 may include the device of example 55, wherein the one or more processors are configured to start a timer for the first scan request at the initiation of the scan, the timer corresponding to an active scanning time for the first scan request, detect a scanning interruption to the scan, stop the timer upon detection of the scanning interruption, and restart the timer at a completion of the scanning interruption.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors of a device, configure the device to:
initiate a scan for advertising packets associated with one or more advertising devices, wherein the scan has a corresponding scan duration;
detect a scanning interruption during the scan;
determine a duration of the scanning interruption; and
extend the scan duration based at least in part on the duration of the scanning interruption.

2. The one or more non-transitory computer-readable media of claim 1, wherein to extend the scan duration includes to:
stop a counter corresponding to a scanning time upon detection of the scanning interruption; and
restart the counter at an end of the scanning interruption.

3. The one or more non-transitory computer-readable media of claim 1, wherein an initial value for the scan duration is determined based on one or more scan parameters, and wherein to extend the scan duration comprises extending the scan duration based on the duration of the scanning interruption.

4. The one or more non-transitory computer-readable media of claim 1, wherein the scan is to be performed within a frequency range and the scanning interruption comprises an unrelated transmission in the frequency range.

5. The one or more non-transitory computer-readable media of claim 1, wherein the scan comprises a first scan operation for a first scan agent and a second scan operation for a second scan agent, and wherein the scan duration is determined based at least in part on the first scan operation and the second scan operation.

6. The one or more non-transitory computer-readable media of claim 5, wherein the first scan operation has a first duty cycle, the second scan operation has a second duty cycle, and the instructions, when executed by the one or more processors, further configure the device to:
perform the scan based on the higher duty cycle of the first duty cycle and the second duty cycle.

7. The one or more non-transitory computer-readable media of claim 5, wherein the first scan operation has a first duty cycle, the second scan operation has a second duty cycle, and the instructions, when executed by the one or more processors, further configure the device to:
perform a first portion of the scan in accordance with the first duty cycle and perform a second portion of the scan in accordance with the second duty cycle.

8. The one or more non-transitory computer-readable media of claim 5, wherein the instructions, when executed by the one or more processors, configure the device to:
recompute a threshold value for a remaining scan time for the second scan operation based at least in part on the first scan operation being modified.

9. A method of performing a scan by a device, comprising:
initiating, by the device, a scan for one or more advertising packets associated with one or more advertising devices, wherein the scan has a corresponding scan duration;
detecting, by the device, a scanning interruption during the scan;
determining, by the device, a duration of the scanning interruption; and
extending, by the device, the scan duration based at least in part on the duration of the scanning interruption.

10. The method of claim 9, wherein extending the scan duration comprises:
stopping a counter corresponding to a scanning time upon detection of the scanning interruption; and
restarting the counter at an end of the scanning interruption.

11. The method of claim 9, wherein an initial value for the scan duration is determined based on one or more scan parameters and extending the scan duration comprises extending the scan duration based on the duration of the scanning interruption.

12. The method of claim 9, wherein the scan is performed for a first scan operation for a first scan agent and a second scan operation for a second scan agent, and the scan duration is determined based at least in part on the first scan operation and the second scan operation.

13. The method of claim 12, wherein the first scan operation has a first duty cycle, the second scan operation has a second duty cycle, and the method further comprises:
performing the scan in accordance with the higher duty cycle of the first duty cycle and the second duty cycle.

14. The method of claim 12, wherein the first scan operation has a first duty cycle, the second scan operation has a second duty cycle, and the method further comprises:
performing the scan using the first duty cycle for a first portion of the scan and the second duty cycle for a second portion of the scan.

15. The method of claim 12, comprising recomputing a threshold value for a remaining scan time for the second scan operation based at least in part on the first scan operation being modified.

16. A device, comprising:
an antenna for performing scanning; and
one or more processors coupled to the antenna, the one or more processors configured to:
initiate a scan for advertising packets associated with one or more advertising devices, wherein the scan has a corresponding scan duration;
detect a scanning interruption during the scan;
determine a duration of the scanning interruption; and
extend the scan duration based at least in part on the duration of the scanning interruption.

17. The device of claim 16, wherein extending the scan duration comprises:
stopping a counter corresponding to the scan upon detection of the scanning interruption; and
restarting the counter at an end of the scanning interruption.

18. The device of claim 16, wherein an initial value for the scan duration is determined based on one or more scan parameters and extending the scan duration comprises extending the scan duration based on the duration of the scanning interruption.

19. The device of claim 16, wherein the scan is to be performed within a frequency range and the scanning interruption comprises an unrelated transmission in the frequency range.

20. The device of claim 16, wherein the scan is performed for a first scan operation for a first scan agent and a second scan operation for a second scan agent, and the scan duration is determined based at least in part on the first scan operation and the second scan operation.
